(19) United States
(12) Patent Application Publication
(10) Pub. No.: US 2012/0060753 A1
(43) Pub. Date: Mar. 15, 2012

(54) Image bearing member-protecting agent, protective layer-forming device using the same, and image forming apparatus

(75) Inventors: Shinya Tanaka, Kanagawa (JP); Hiroshi Nakai, Kanagawa (JP); Kunio Hasegawa, Kanagawa (JP); Kohsuke Yamamoto, Kanagawa (JP); Taichi Urayama, Kanagawa (JP)

(73) Assignee: Ricoh Company, Ltd., Tokyo (JP)

(21) Appl. No.: 13/137,782

(22) Filed: Sep. 13, 2011

(30) Foreign Application Priority Data
Sep. 15, 2010 (JP) 2010-206696

(51) Int. Cl. B05C 11/04; C09D 191/00

(52) U.S. Cl. 118/100; 106/243

(57) ABSTRACT

An image bearing member-protecting agent including a fatty acid metal salt and boron nitride, wherein the image bearing member-protecting agent contains the fatty acid metal salt in an amount of 60% by mass to 87% by mass, and is formed by compression molding; or an image bearing member-protecting agent including a fatty acid metal salt and boron nitride, wherein the image bearing member-protecting agent contains the fatty acid metal salt in an amount of 88% by mass to 99% by mass, and is formed by melt molding.

### BACKGROUND OF THE INVENTION

1. Field of the Invention

The present invention relates to an image bearing member-protecting agent containing at least a fatty acid metal salt and boron nitride, a protective layer-forming device using the image bearing member-protecting agent, and an image forming apparatus.

2. Description of the Related Art

Conventionally, in electrophotographic image formation, a latent electrostatic image is formed on an image bearing member such as a photoconductor, and charged toner particles are attached to this latent electrostatic image so as to form a visible image. The visible image formed with the toner particles is transferred onto a transfer medium such as paper, then fixed on the transfer medium utilizing heat, pressure, solvent gas, etc. and thus formed as an output image. Methods for the image formation are broadly classified, according to how toner particles for image visualization are charged, into so-called two-component developing methods in which frictional charging effected by agitating and mixing toner particles and carrier particles is utilized, and so-called one-component developing methods in which toner particles are charged without using carrier particles. Further, the one-component developing methods are classified into magnetic one-component developing methods and nonmagnetic one-component developing methods, according to whether or not magnetic force is utilized to keep toner particles on a developing roller.

Hitherto, in copiers, complex machines based upon the copiers, and the like for which high-speed processing capability and favorable image reproducibility are required, the two-component developing methods have been employed in many cases due to demands for stable chargeability of toner particles, stable charge rising properties of the toner particles, long-term stability of image quality, etc.; whereas in compact printers, facsimiles, etc. for which space saving, cost reduction and the like are required, the one-component developing methods have been employed in many cases.

Generally, in an image forming apparatus which operates in accordance with any such electrophotographic image forming method, regardless of which developing method is employed, a drum-shaped or belt-shaped image bearing member is uniformly charged while being rotated, a latent image pattern is formed on the image bearing member by laser light or the like, and the latent image pattern is visualized as a toner image by a developing device and transferred onto a transfer medium by a transfer device.

After the toner image has been transferred onto the transfer medium, untransferred toner components remain on the image bearing member. When such residues are directly conveyed to a place for the charging step, it often hinders the image bearing member from being uniformly charged. Accordingly, in general, the toner components, etc. remaining on the image bearing member are removed at a cleaning step after the transfer step, thereby bringing the surface of the image bearing member into a sufficiently clean state, and then the charging step is performed.

In each step in image formation, there are mechanical stress applied to the image bearing member and the cleaning blade caused by friction therebetween and electrical stress applied to the image bearing member caused by discharge at the charging and transfer steps. These stresses disadvantageously shorten the service lives of the image bearing member and cleaning member.

In view of this, for example, Japanese Patent Application Publication (JP-B) No. 51-22380 proposes applying, onto the surface of an image bearing member, an image bearing member-protecting agent containing zinc stearate as a main ingredient. This can improve lubricity on the image bearing member surface, can suppress abrasion of the image bearing member and a cleaning member, and can increase cleanability to toner particles remaining after transfer.

Also, Japanese Patent Application Laid-Open (JP-A) No. 2006-350240 proposes applying, onto a surface of an image bearing member, an image bearing member-protecting agent containing boron nitride and a fatty acid metal salt such as zinc stearate. This literature describes that the image bearing member-protecting agent containing boron nitride in combination with the fatty acid metal salt can impart lubricity to the image bearing member surface for a longer time than the case of the image bearing member-protecting agent containing the fatty acid metal salt alone to thereby prevent toner particles from passing through the gap between the image bearing member and other members in contact therewith, even when the image bearing member-protecting agent is affected by discharge performed at the charging step in the vicinity of the image bearing member. In general, properties of boron nitride are not easily changed even by discharge. Thus, even when affected by discharge, boron nitride does not easily lose its lubricity as compared with the fatty acid metal salt.

Notably, JP-A No. 2006-350240 describes, as a molding method for a block of an image bearing member-protecting agent, compression molding in which a powdery lubricant is placed in a mold where the powdery lubricant is molded through application of pressure, and melt molding in which a powdery lubricant is heated/melted and then poured into a mold, followed by cooling. Also, JP-A No 2007-145993 proposes an image bearing member-protecting agent containing at least two higher fatty acid metal salts having different numbers of carbon atoms in order to increase moldability of a block of an image bearing member-protecting agent having a high aspect ratio.

### BRIEF SUMMARY OF THE INVENTION

The present inventors conducted extensive studies and have found that image bearing member-protecting agents each containing a fatty acid metal salt as a main component greatly differ from each other in terms of their consumption rates (i.e., the amounts of the image bearing member-protecting agents scraped off with increasing of the number of images formed) depending on the amount of an inorganic additive contained (e.g., boron nitride) and the molding method employed. When the consumption rate is too high, the fatty acid metal salt itself tends to pass through the gap between the image bearing member and other members in contact therewith, resulting in that the fatty acid metal salt may be scattered to contaminate charging members. Whereas when the consumption rate is too low, it is difficult to form a protective layer on the image bearing member, potentially causing abrasion and filming of the image bearing member.

Notably, JP-A No. 2006-350240 additionally describes the molding method of the image bearing member-protecting agent, but does not describe that what type of the molding method should be employed for the compositions of the image bearing member-protecting agents. JP-A No. 2007-145993 proposes using two or more fatty acid metal salts having carbon atoms different in number. However, use of different fatty acid metal salts allows the formed protecting agent to be decreased in lubricity, easily causing passing through of toner particles and contamination of charging members.

The present invention aims to solve the above existing problems and achieve the following objects. Specifically, an object of the present invention is to provide: an image bearing member-protecting agent including at least a fatty acid metal salt and boron nitride, which agent can prevent toner particles from passing through the gap between the image bearing member and other members in contact therewith, can prevent contamination of charging members, can prevent abrasion and filming of the image bearing member, and can stably form high-quality images for a long period of time; and a protective layer-forming device and an image forming apparatus each using the image bearing member-protecting agent.

Means for solving the above existing problems are as follows.

<1> An image bearing member-protecting agent including:

a fatty acid metal salt, and

boron nitride,

wherein the image bearing member-protecting agent contains the fatty acid metal salt in an amount of 60% by mass to 87% by mass, and is formed by compression molding.

<2> An image bearing member-protecting agent including:

a fatty acid metal salt, and

boron nitride,

wherein the image bearing member-protecting agent contains the fatty acid metal salt in an amount of 88% by mass to 99% by mass, and is formed by melt molding.

<3> The image bearing member-protecting agent according to <1> or <2>, wherein the fatty acid metal salt is zinc stearate.

<4> A protective layer-forming device including:

an image bearing member-protecting agent,

wherein the protective layer-forming device is configured to apply or attach the image bearing member-protecting agent onto a surface of an image bearing member, and

wherein the image bearing member-protecting agent is the image bearing member-protecting agent according to any one of <1> to <3>.

<5> The protective layer-forming device according to <4>, further including a protecting agent-supplying member,

wherein the protecting agent-supplying member scrapes off the image bearing member-protecting agent and comes into contact with the image bearing member to supply the image bearing member-protecting agent to the image bearing member.

<6> The protective layer-forming device according to <4> or <5>, further including a coating film-forming member,

wherein the coating film-forming member presses the image bearing member-protecting agent supplied onto the image bearing member to form a coating film on the image bearing member.

<7> An image forming apparatus including:

an image bearing member configured to bear a toner image,

a transfer unit configured to transfer the toner image on the image bearing member onto a transfer medium, and

a protective layer-forming unit configured to apply or attach an image bearing member-protecting agent onto a surface of the image bearing member from which the toner image has been transferred onto the transfer medium,

wherein the image bearing member-protecting agent is the image bearing member-protecting agent according to any one of <1> to <3>.

<8> The image forming apparatus according to <7>, further including a cleaning unit configured to remove a toner remaining on the surface of the image bearing member,

wherein the cleaning unit is located downstream of the transfer unit but upstream of the protective layer-forming unit in a direction in which the image bearing member is moved.

<9> The image forming apparatus according to <7> or <8>, wherein the image bearing member includes an uppermost layer containing a thermosetting resin.

<10> The image forming apparatus according to any one of <7> to <9>, wherein the image bearing member is a photoconductor.

<11> The image forming apparatus according to any one of <7> to <10>, further including a charging unit configured to uniformly charge the surface of the image bearing member in a state where the charging unit is brought into contact with or disposed proximately to the surface of the image bearing member.

<12> The image forming apparatus according to <11>, wherein the charging unit includes a voltage-applying unit configured to apply a voltage containing an alternating-current component.

<13> The image forming apparatus according to any one of <7> to <9>, wherein the image bearing member is an intermediate transfer medium.

<14> The image forming apparatus according to any one of <7> to <13>, wherein the toner image is formed with a toner having a circularity of 0.93 to 1.00 where the circularity is calculated by the following: Circumferential length of circle having the same area as projected particle area/Circumferential length of projected particle image.

<15> The image forming apparatus according to any one of <7> to <14>, wherein the toner image is formed with a toner having a ratio D4/D1 of 1.00 to 1.40 where D4 denotes a weight average particle diameter of the toner and D1 denotes a number average particle diameter of the toner.

<16> The image forming apparatus according to any one of <7> to <15>, wherein at least the image bearing member and the protective layer-forming unit are integrally included in a process cartridge which is detachably mounted to a main body of the image forming apparatus.

Regarding the invention described in <1> above, the image bearing member-protecting agent containing a fatty acid metal salt as a main component and formed by compression molding can relatively be prevented from being hard even by the addition of components other than the fatty acid metal salt. This image bearing member-protecting agent contains the other components than the fatty acid metal salt in such an amount as to compensate a great change in consumption rate as seen in image bearing member-protecting agents formed by compression molding. The compression-molded image bearing member-protecting agents are too high in consumption rate at an early stage, and the fatty acid metal salt itself passes through the gap between the image bearing member and other members in contact therewith, potentially contaminating a charging member. However, addition of the other components than the fatty acid metal salt can reduce the absolute amount of the fatty acid metal salt itself passing through the gap therebetween. Also, the other components (e.g., boron nitride) added in a sufficient amount have a great effect of maintaining lubricity to prevent toner particles from passing through the gap therebetween. Notably, in the compression-molded image bearing member-protecting agent containing a fatty acid metal salt as a main component, when the amount of the other components than the fatty acid metal salt exceeds 40% by mass, the obtained image bearing member-protecting agent becomes hard to be considerably decreased in consumption rate, causing abrasion and filming of the image bearing member, which is not preferred.

Regarding the invention described in <2> above, the image bearing member-protecting agent containing a fatty acid metal salt as a main component and formed by melt molding cannot contain a large amount of the other components (e.g., boron nitride) than the fatty acid metal salt since it tends to be hard by the addition of the other components, but can maintain relatively stable consumption rate. Thus, the melt-molded image bearing member-protecting agent can relatively stably supply the image bearing member-protecting agent to the image bearing member even when it contains a small amount of the other components than the fatty acid metal salt. Notably, when the other components such as boron nitride are contained in the melt-molded image bearing member-protecting agent in an amount of 1% by mass or more, improvement in lubricity can be expected to obtain by the addition of the other components such as boron nitride. Whereas the other components than the fatty acid metal salt is contained in an amount exceeding 12% by mass, the obtained image bearing member-protecting agent becomes hard to be considerably decreased in consumption rate, causing abrasion and filming of the image bearing member, which is not preferred.

The present invention can provide an image bearing member-protecting agent including at least a fatty acid metal salt and boron nitride, which agent can prevent toner particles from passing through the gap between the image bearing member and other members in contact therewith, can prevent contamination of charging members, can prevent abrasion and filming of the image bearing member, and can stably form high-quality images for a long period of time; and a protective layer-forming device and an image forming apparatus each using the image bearing member-protecting agent. These can solve the above existing problems and achieve the above object.

### BRIEF DESCRIPTION OF THE DRAWINGS

FIG. 1 illustrates the configurations of essential parts in a printer according to the present embodiment.

FIG. 2 illustrates the configurations of a photoconductor, a cleaning unit and a protective layer-forming unit in the printer illustrated in FIG. 1.

FIG. 3 is a graph of the relationship between the number of formed images and consumption rates of protecting agent blocks formed by melt molding per travel distance.

FIG. 4 is a graph of the relationship between the number of formed images and consumption rates of protecting agent blocks formed by compression molding per travel distance.

### DETAILED DESCRIPTION OF THE INVENTION

### (Image Bearing Member-Protecting Agent)

An image bearing member-protecting agent according to one embodiment of the present invention contains at least a fatty acid metal salt and boron nitride; and, if necessary, further contains other ingredients, wherein the image bearing member-protecting agent contains the fatty acid metal salt in an amount of 60% by mass to 87% by mass, and is formed by compression molding.

An image bearing member-protecting agent according to another embodiment of the present invention contains at least a fatty acid metal salt and boron nitride; and, if necessary, further contains other ingredients, wherein the image bearing member-protecting agent contains the fatty acid metal salt in an amount of 88% by mass to 99% by mass, and is formed by melt molding.

### (Protective Layer-Forming Device)

A protective layer-forming device of the present invention includes an image bearing member-protecting agent, wherein the protective layer-forming device is configured to apply or attach the image bearing member-protecting agent onto a surface of an image bearing member. Here, the image bearing member-protecting agent must be the image bearing member-protecting agent of the present invention.

### (Image Forming Apparatus)

An image forming apparatus of the present invention includes an image bearing member configured to bear a toner image, a transfer unit configured to transfer the toner image on the image bearing member onto a transfer medium, and a protective layer-forming unit configured to apply or attach an image bearing member-protecting agent onto a surface of the image bearing member from which the toner image has been transferred onto the transfer medium; and, if necessary, further includes other units such as a cleaning unit and a charging unit. Here, the image bearing member-protecting agent must be the image bearing member-protecting agent of the present invention.

The image bearing member preferably has an uppermost layer containing a thermosetting resin. Also, the image bearing member is preferably a photoconductor or an intermediate transfer medium.

The image forming apparatus of the present invention preferably includes a cleaning unit configured to remove a toner remaining on the surface of the image bearing member, wherein the cleaning unit is located downstream of the transfer unit but upstream of the protective layer-forming unit in a direction in which the image bearing member is moved.

The image forming apparatus of the present invention preferably includes a charging unit configured to uniformly charge the surface of the image bearing member in a state where the charging unit is brought into contact with or disposed proximately to the surface of the image bearing member. Also, the charging unit preferably includes a voltage-applying unit configured to apply a voltage containing an alternating-current component.

Furthermore, in the image forming apparatus of the present invention, preferably, at least the image bearing member and the protective layer-forming unit are integrally included in a process cartridge which is detachably mounted to a main body of the image forming apparatus.

Next will be described an embodiment where the image bearing member-protecting agent of the present invention is applied to a color printer which is an electrophotographic image forming apparatus.

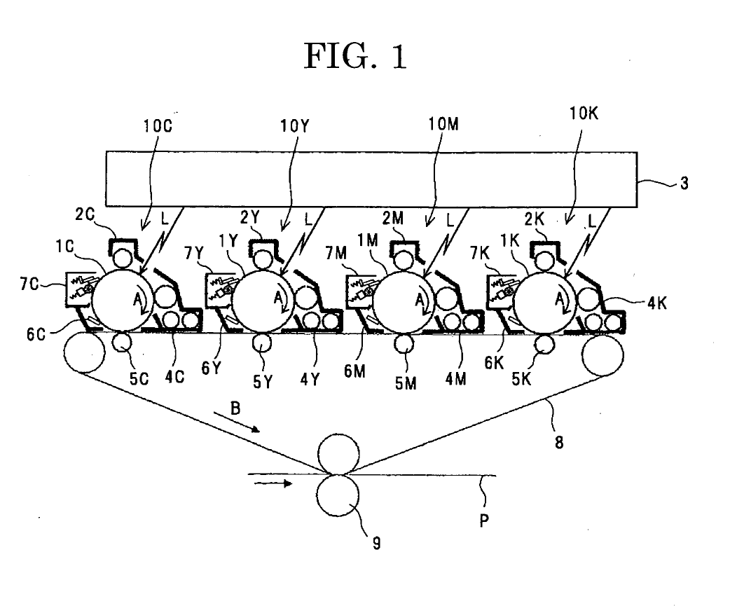

FIG. 1 illustrates the configuration of essential parts in a printer according to the present embodiment. As illustrated in FIG. 1, this printer includes four image forming units 10C, 10Y, 10M and 10K configured respectively to form toner images of yellow, magenta, cyan and black, and an intermediate transfer belt 8, where the image forming units are arranged at regular intervals along a horizontally extended part of the intermediate transfer belt. The characters C, Y, M and K means respectively cyan, yellow, magenta and black, but they may be omitted in the following description.

The image forming units 10C, Y, M and K respectively have photoconductors 1C, Y, M and K each serving as an image bearing member rotated in a direction indicated by the arrow A. The photoconductors 1C, Y, M and K are provided therearound with charging rollers 2C, Y, M and K, developing devices 4C, Y, M and K, transfer rollers 5C, Y, M and K, cleaning units 6C, Y, M and K, and protective layer-forming units 7C, Y, M and K in this order. Also, an exposing device 3 is provided above the image forming unit 10.

The charging roller 2 is a charging unit which is disposed so as to be in contact with or proximately to a surface of the photoconductor 1 and which is configured to apply bias to charge the photoconductor 1 at a predetermined polarity and a predetermined potential.

The exposing device 3 employs a LD or LED as a light-emitting element, and applies light modulated based on image information to the photoconductor 1 charged with the charging roller 2 to form a latent electrostatic image on the photoconductor 1.

The developing device 4 has a rotatable developing sleeve and a magnet roller fixed therein, and carries a developer on the developing sleeve. In the present embodiment, the developing device employs a developing method of performing development using a magnetic brush and a two-component developer containing a toner and a carrier, but may employ a developing method of performing development using a one-component developer containing no carrier. A voltage is applied to the developing sleeve from a developing bias power source. Utilizing the difference in potential between the developing bias and the latent electrostatic image formed on the surface of the photoconductor 1, charged toner particles are attached to develop the latent electrostatic image at a developing region.

The transfer roller 5 is a transfer unit configured to transfer a toner image from the image bearing member onto a transfer medium. Upon image transfer, the transfer roller comes into contact with the surface of the photoconductor 1 at a predetermined pressing force and applies a voltage to the surface of the photoconductor 1, to thereby transfer the toner image from the surface of the photoconductor 1 to the intermediate transfer belt 8 at a transfer nip portion between the photoconductor 1 and the transfer roller 5.

The cleaning unit 6 is, as described below, a cleaning unit configured to remove residual matter such as residual toner remaining on the photoconductor 1 after transfer and the protecting agent degraded by discharge.

The protective layer-forming unit 7 corresponds to the protective layer-forming device of the present invention or the protective layer-forming unit in the image forming apparatus of the present invention, and is configured to form a protective layer by applying or attaching the image bearing member-protecting agent of the present invention onto the surface of the photoconductor 1 serving as an image bearing member.

The intermediate transfer belt 8 is supported in a stretched manner by a plurality of conveyance rollers including a driving roller so that the intermediate transfer belt can be moved in a direction indicated by arrow B in FIG. 1. A secondary transfer roller 9 is disposed downstream of the image forming units 10C, Y, M and K in the moving direction of the intermediate transfer belt 8. Toner images developed on the photoconductors 1 by the image forming units 10C, Y, M and K are sequentially transferred on the intermediate transfer belt 8 to which transfer voltages are applied by the corresponding transfer rollers 5. A composite toner image formed of yellow, cyan, magenta and black images transferred on the intermediate transfer belt 8 in a superposed manner is transferred onto a paper sheet P by a secondary transfer roller 9. The composite toner image is fixed on the paper sheet P by a fixing device.

The above image forming unit 10 is formed as a process cartridge detachably mounted to a main body of the apparatus, the process cartridge including the photoconductor 1, charging roller 2, developing device 4, transfer roller 5, cleaning unit 6 and protective layer-forming unit 7 so that these are supported integrally. As described above, the image forming unit 10 is configured such that it can be entirely replaced. Alternatively, the image forming unit 10 may be configured such that the photoconductor 1, charging roller 2, developing device 4, transfer roller 5, cleaning unit 6, and protective layer-forming unit 7 can independently be replaced with new one.

Next will be described the configurations of the cleaning unit 6 and the protective layer-forming unit 7.

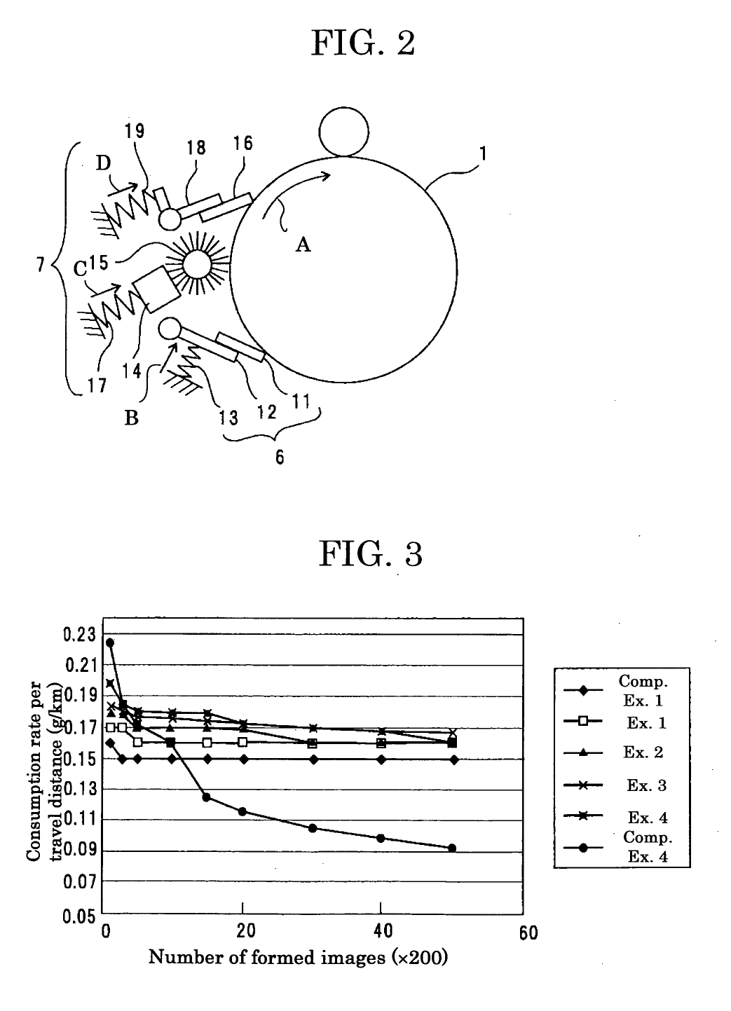

FIG. 2 illustrates the configurations of the photoconductor, cleaning unit and protective layer-forming unit. As illustrated in FIG. 2, the cleaning unit 6 has a cleaning blade 11 which removes residual matter on the photoconductor 1. The cleaning blade 11 is fixed on and supported by a rotatably-supported holder 12 in a counter manner with respect to the rotation direction of the photoconductor 1 (i.e., the direction indicated by arrow A in FIG. 2). The cleaning blade 11 is pressed by a press spring 13 against the photoconductor 1 in the direction indicated by arrow B in FIG. 2 to thereby remove residual toner particles. Notably, the cleaning blade is provided in the cleaning unit in the present embodiment, but conventionally known cleaning members may be employed.

The protective layer-forming device and the protective layer-forming unit preferably have a protecting agent-supplying member which scrapes off the image bearing member-protecting agent and comes into contact with the image bearing member to supply the image bearing member-protecting agent to the image bearing member. Also, they preferably have a coating film-forming member which presses the image bearing member-protecting agent supplied onto the image bearing member to form a coating film on the image bearing member.

The protective layer-forming unit 7 contains, for example, the below-described protecting agent block 14, application brush 15 serving as the protecting agent-supplying member which supplies the protecting agent to the photoconductor 1, and leveling blade 16 serving as the coating film-forming member which levels the protecting agent supplied on the photoconductor 1 to form a coating film. The application brush 15 is rotated so as to have a predetermined difference in linear velocity with respect to the photoconductor 1, while being controlled in rotation speed by a drive motor capable of controlling the rotation speed. The application brush 15 scrapes off the protecting agent block 14 to form fine powder and supplies the fine powder to the photoconductor 1.

The application brush 15 may be, for example, a roller brush formed by spirally winding a tape with a pile of brush fibers around a metal core. Here, the protecting agent block 14 is pressed by a press spring 17 against the application brush 15 in the direction indicated by arrow C in FIG. 2. The force with which the press spring 17 presses the protecting agent block may be the force with which the protecting agent is spread and formed into a protective layer on the photoconductor 1. The force is preferably 5 gf/cm to 80 gf/cm, more preferably 10 gf/cm to 60 gf/cm, as a linear pressure.

Also, since there may be a case where the protecting agent supplied by the application brush 15 onto the photoconductor 1 does not satisfactorily form a protective layer during the supply of the protecting agent, the leveling blade 16 is preferably provided to form a more uniform protective layer. The leveling blade 16 is fixed on and supported by a rotatably-supported holder 18 in a trading manner with respect to the rotation direction of the photoconductor 1. The leveling blade 16 is pressed by a press spring 19 against the photoconductor 1 in the direction indicated by arrow D in FIG. 2, to thereby level the protecting agent on the photoconductor 1 to attain a densely applied state.

Notably, as in the present embodiment, when the leveling blade 16 for leveling the protecting agent is provided, this leveling blade 16 may serve also as a cleaning member. However, the cleaning function of removing residual matter from the photoconductor 1 is preferably separated from the leveling function of leveling the protective layer on the photoconductor 1, since proper cleaning and leveling may require a member to slide differently. To more reliably form a uniform protective layer, preferably, residual matter mainly containing toner is removed in advance with the cleaning blade 11 from the photoconductor 1 so as to avoid inclusion of the residual matter in the protective layer. For this reason, in the present embodiment, the cleaning unit 6 is provided upstream of the protective layer-forming unit 7 in the moving direction of the photoconductor as illustrated in FIG. 2.

Here, the protecting agent block 14 used in the protective layer-forming unit 7 is produced as follows. The protecting agent block 14 used in the present embodiment must contain at least a fatty acid metal salt and boron nitride. The consumption rate of this protecting agent block 14 containing the fatty acid metal salt as a main component depends on the molding method employed and/or the amount of inorganic additives (e.g., boron nitride).

In view of this, when the other components (e.g., boron nitride) than the fatty acid metal salt are contained in the protecting agent in an amount of 13% by mass to 40% by mass, the protecting agent block 14 is produced by compression molding. In the compression molding, powder mainly containing a fatty acid metal salt and boron nitride is mixed, and the mixed powder is charged to a mold, followed by application of pressure in the mold, to thereby produce the protecting agent block 14. The compression-molded protecting agent block involves a great change in consumption rate, but can compensate failures due to that great change by components such as boron nitride contained in a sufficient amount. Notably, the compression-molded protecting agent block 14 can be prevented from being too hardened even by the addition of the other components such as boron nitride. However, when the amount of the other components exceeds 40% by mass, the compression-molded protecting agent block becomes hard and decreases in consumption rate, which is not preferred.

That is, an image bearing member-protecting agent according to a first embodiment of the present invention includes at least a fatty acid metal salt and boron nitride, wherein the image bearing member-protecting agent contains the fatty acid metal salt in an amount of 60% by mass to 87% by mass, and is formed by compression molding.

Meanwhile, when the other components (e.g., boron nitride) than the fatty acid metal salt are contained in the protecting agent in an amount of 1% by mass to 12% by mass, the protecting agent block 14 is produced by melt molding. In the melt molding, powder mainly containing a fatty acid metal salt and boron nitride is mixed, and the mixed powder is heated/melted and then poured into a mold, followed by cooling, to thereby produce the protecting agent block 14. In the case of the melt molding, when the amount of the boron nitride does not exceed a certain amount, the protecting agent block can be prevented from involving a change in consumption rate. However, when the amount of the other components (e.g., boron nitride) than the fatty acid metal salt exceeds 12%, the melt-molded protecting agent block 14 becomes too hard and decreases in consumption rate, which is not preferred.

That is, an image bearing member-protecting agent according to a second embodiment of the present invention includes at least a fatty acid metal salt and boron nitride, wherein the image bearing member-protecting agent contains the fatty acid metal salt in an amount of 88% by mass to 99% by mass, and is formed by melt molding.

The fatty acid metal salt used for the protecting agent block 14 of the protective layer-forming unit 7 is not particularly limited and may be appropriately selected depending on the intended purpose. Examples of the fatty acid metal salt include barium stearate, lead stearate, iron stearate, nickel stearate, cobalt stearate, copper stearate, strontium stearate, calcium stearate, cadmium stearate, magnesium stearate, zinc stearate, zinc oleate, magnesium oleate, iron oleate, cobalt oleate, copper oleate, lead oleate, manganese oleate, zinc palmitate, cobalt palmitate, lead palmitate, magnesium palmitate, aluminum palmitate, calcium palmitate, lead caprylate, lead caprate, zinc linoleate, cobalt linoleate, calcium linoleate, zinc ricinoleate, cadmium ricinoleate and mixtures thereof. These may be used in combination.

Among the above fatty acid metal salts, zinc stearate is particularly preferably used. This is because zinc stearate is more excellent than the other fatty acid metal salts in cleanability and protectability to a photoconductor (extendability on the photoconductor). Also, stearic acid is the cheapest among higher fatty acids. Furthermore, a zinc salt of stearic acid is a highly hydrophobic, remarkably stable compound.

In addition to the fatty acid metal salt, the protecting agent block 14 must contain boron nitride as the other component. The other component may further contain other inorganic additives such as lubricating ingredients; e.g., mica, molybdenum disulfide, tungsten disulfide, talc, kaolin, montmorillonite, calcium fluoride and graphite and polishing ingredients; e.g., silica, alumina, titania, zirconia, magnesia, ferrite and magnetite. Notably, the lubricating ingredient and the polishing ingredient of the inorganic additives contribute similarly to the hardness of the protecting agent block 14.

In order to reduce mechanical stress of the application brush 15 of the protective layer-forming unit 7 against the surface of the photoconductor 1, flexible brush fibers preferably employed. The materials for the flexible brush fibers are not particularly limited and one or more generally known materials may be used depending on the intended purpose. Specifically, the material for the flexible brush fibers may be resins having flexibility selected from the following materials: polyolefin resins (e.g., polyethylene and polypropylene); polyvinyl resins and polyvinylidene resins (e.g., polystyrene, acrylic resins, polyacrylonitrile, polyvinyl acetate, polyvinyl alcohol, polyvinyl butyral, polyvinyl chloride, polyvinyl carbazole, polyvinyl ethers and polyvinyl ketones); vinyl chloride-vinyl acetate copolymers; styrene-acrylic acid copolymers; styrene-butadiene resins; fluorine resins (e.g., polytetrafluoroethylene, polyvinyl fluoride, polyvinylidene fluoride and polychlorotrifluoroethylene); polyesters; nylons; acrylics; rayon; polyurethanes; polycarbonates; phenol resins; amino resins (e.g. urea-formaldehyde resins, melamine resins, benzoguanamine resins, urea resins and polyamide resins); and so forth. To adjust the extent to which the brush bends, diene-based rubber, styrene-butadiene rubber (SBR), ethylene propylene rubber, isoprene rubber, nitrile rubber, urethane rubber, silicone rubber, hydrin rubber, norbornene rubber and the like may be used in combination.

Each of the brush fibers of the application brush 15 preferably has a diameter of about 10 μm to about 500 μm and a length of 1 mm to 15 mm, and the number of the brush fibers (brush fiber density) is preferably 10,000 to 300,000 per square inch (1.5×10⁷ to 4.5×10⁸ per square meter). For the application brush, use of a material having a high brush fiber density is highly desirable in terms of uniformity and stability of the supply; for example, it is desirable that one fiber be formed from several to several hundreds of fine fibers. More specifically, 50 fine fibers of 6.7 decitex (6 denier) may be bundled together and planted as one fiber, as exemplified by the case of 333 decitex=6.7 decitex×50 filaments (300 denier=6 denier×50 filaments).

Additionally, if necessary, the surface of the application brush 15 may be provided with a coating layer for the purpose of stabilizing the shape of the brush surface, the environmental stability, etc. As component(s) of the coating layer, use of component(s) capable of deforming in a manner that conforms to the bending of the brush fibers is preferable, and the component(s) is/are not limited in any way as long as it/they can maintain its/their flexibility. Examples of the component(s) include polyolefin resins such as polyethylene, polypropylene, chlorinated polyethylene and chlorosulfonated polyethylene; polyvinyl resins and polyvinylidene resins, such as polystyrene, acrylics (e.g., polymethyl methacrylate), polyacrylonitrile, polyvinyl acetate, polyvinyl alcohol, polyvinyl butyral, polyvinyl chloride, polyvinyl carbazole, polyvinyl ethers and polyvinyl ketones; vinyl chloride-vinyl acetate copolymers; silicone resins including organosiloxane bonds, and modified products thereof (e.g., modified products made of alkyd resins, polyester resins, epoxy resins, polyurethanes, etc.); fluorine resins such as perfluoroalkyl ethers, polyfluorovinyl, polyfluorovinylidene and polychlorotrifluoroethylene; polyamides; polyesters; polyurethanes; polycarbonates; amino resins such as urea-formaldehyde resins; epoxy resins; and composite resins thereof.

The material for the leveling blade 16 used in the protective layer-forming unit 7 is not particularly limited. Examples of the material include elastic materials such as urethane rubber, hydrin rubber, silicone rubber and fluorine rubber, which are generally known as materials for cleaning blades. These elastic materials may be used alone or as a blend. Additionally, a portion of such a rubber blade which comes into contact with the photoconductor 1 may be coated or impregnated with a low-friction-coefficient material. Further, in order to adjust the hardness of the elastic material used, a filling material such as an organic or inorganic filler may be dispersed.

The leveling blade 16 formed of these materials is fixed on a holder in any method such as adhesion or fusion so that the free end thereof can be pressed against the surface of the photoconductor 1. Although the thickness of the leveling blade 16 cannot be unequivocally defined because the thickness is decided in view of the force applied by the pressing, the leveling blade preferably has a thickness of about 0.5 mm to about 5 mm, more preferably about 1 mm to about 3 mm. Similarly, although the length of the leveling blade which protrudes from the holder and may bend (so-called free length) cannot be unequivocally defined because the length is decided in view of the force applied by the pressing, the length is preferably about 1 mm to about 15 mm, more preferably about 2 mm to about 10 mm.

Another structure of the leveling blade 16 may be employed in which a surface layer of a resin, rubber, elastomer, etc. is formed over a surface of an elastic metal blade such as a spring plate, using a coupling agent, a primer component, etc. if necessary, by a method such as coating or dipping, then subjected to thermal curing, etc. if necessary, and further, subjected to surface polishing, etc. if necessary. In this case, the thickness of the elastic metal blade is preferably about 0.05 mm to about 3 mm, more preferably about 0.1 mm to about 1 mm. In order to prevent the elastic metal blade from being twisted, the blade may, for example, be bent in a direction substantially parallel to the support shaft after the installation of the blade. As the material for the surface layer, a fluorine resin such as PFA, PTFE, FEP or PVdF, a fluorine-based rubber, a silicone-based elastomer such as methylphenyl silicone elastomer, or the like may be used with the addition of a filler if necessary. However, the material is not limited thereto.

Next, the photoconductor 1 suitably used in the present invention will be described. The photoconductor used in the present invention includes a conductive substrate and a photoconductive layer provided on the conductive substrate. The structure of the photosensitive layer is selected from a single-layer structure in which a charge generating material and a charge transporting material are present in a mixed manner, a normal layer structure in which a charge transporting layer is provided on a charge generating layer, and an inverted layer structure in which a charge generating layer is provided on a charge transporting layer. Additionally, a protective layer may be provided on the photosensitive layer, in order to improve the mechanical strength, abrasion resistance, gas resistance, cleanability, etc. of the photoconductor. Further, an underlying layer may be provided between the photoconductive layer and the conductive substrate. Also, if necessary, an appropriate amount of a plasticizer, an antioxidant, a leveling agent, etc. may be added to each layer.

The conductive substrate of the photoconductor 1 used in the present invention can be made of a material exhibiting conductivity of 10¹⁰ Ω·cm or less in volume resistance. Examples thereof include a product formed by coating a film-like or cylindrical piece of plastic or paper with a metal such as aluminum, nickel, chromium, Nichrome, copper, gold, silver or platinum or with a metal oxide such as tin oxide or indium oxide by means of vapor deposition or sputtering; a plate of aluminum, an aluminum alloy, nickel, stainless steel, etc.; and a tube produced by forming the plate into a drum-shaped mother tube by means of extrusion, drawing, etc. and then surface-treating the mother tube by means of cutting, superfinishing, polishing, etc.

The conductive substrate has a drum shape the diameter of which is 20 mm to 150 mm, preferably 24 mm to 100 mm, more preferably 28 mm to 70 mm. When the drum-shaped conductive substrate has a diameter of 20 mm or less, it is physically difficult to place, around the photoconductor, members for the steps of charging, exposing, developing, transferring and cleaning. When the drum-shaped conductive substrate has a diameter of 150 mm or greater, it is undesirable because the image forming apparatus is enlarged. Particularly in the case where an image forming apparatus is of tandem type, it is necessary to mount a plurality of photoconductors therein, so that the diameter of the substrate of each photoconductor is preferably 70 mm or less, more preferably 60 mm or less.

Also, the endless nickel belt and the endless stainless steel belt disclosed in JP-A No. 52-36016 can be used as conductive substrates.

Examples of the underlying layer of the photoconductor 1 include a layer composed mainly of resin, a layer composed mainly of white pigment and resin, and an oxidized metal film obtained by chemically or electrochemically oxidizing the surface of a conductive substrate, with a layer composed mainly of white pigment and resin being preferred. Examples of the white pigment include metal oxides such as titanium oxide, aluminum oxide, zirconium oxide and zinc oxide. Among them, it is most desirable to use titanium oxide that is superior in preventing penetration of electric charge from the conductive substrate. Examples of the resin used for the underlying layer include thermoplastic resins such as polyamide, polyvinyl alcohol, casein and methyl cellulose, and thermosetting resins such as acryl resin, phenol resins, melamine resins, alkyd resins, unsaturated polyesters and epoxy resins. These may be used alone or in combination.

Examples of the charge generating material of the photoconductor 1 used in the present invention include azo pigments such as monoazo pigments, bisazo pigments, trisazo pigments and tetrakisazo pigments; organic pigments and dyes such as triarylmethane dyes, thiazine dyes, oxazine dyes, xanthene dyes, cyanine pigments, styryl pigments, pyrylium dyes, quinacridone pigments, indigo pigments, perylene pigments, polycyclic quinone pigments, bisbenzimidazole pigments, indanthrone pigments, squarylium pigments and phthalocyanine pigments; and inorganic materials such as selenium, selenium-arsenic, selenium-tellurium, cadmium sulfide, zinc oxide, titanium oxide and amorphous silicon. These may be used alone or in combination. The underlying layer may have a single-layer structure or a multilayer structure.

Examples of the charge transporting material of the photoconductor 1 used in the present invention include anthracene derivatives, pyrene derivatives, carbazole derivatives, tetrazole derivatives, metallocene derivatives, phenothiazine derivatives, pyrazoline compounds, hydrazone compounds, styryl compounds, styryl hydrazone compounds, enamine compounds, butadiene compounds, distyryl compounds, oxazole compounds, oxadiazole compounds, thiazole compounds, imidazole compounds, triphenylamine derivatives, phenylenediamine derivatives, aminostilbene derivatives and triphenylmethane derivatives. These may be used alone or in combination.

Binder resin(s) used for forming the photoconductive layer composed of the charge generating layer and the charge transporting layer is electrically insulative and may be selected from thermoplastic resins, thermosetting resins, photocurable resins, photoconductive resins and the like which are known per se. Suitable binder resins are not particularly limited and may be appropriately selected depending on the intended purpose. Examples thereof include thermoplastic resins such as polyvinyl chloride, polyvinylidene chloride, vinyl chloride-vinyl acetate copolymers, vinyl chloride-vinyl acetate-maleic anhydride copolymers, ethylene-vinyl acetate copolymers, polyvinyl butyrals, polyvinyl acetals, polyesters, phenoxy resins, (meth)acrylic resins, polystyrenes, polycarbonates, polyarylates, polysulfone, polyethersulfone and ABS resins; thermosetting resins such as phenol resins, epoxy resins, urethane resins, melamine resins, isocyanate resins, alkyd resins, silicone resins and thermosetting acrylic resins; and photoconductive resins such as polyvinylcarbazole, polyvinylanthracene and polyvinylpyrene. These may be used alone or in combination.

Examples of the antioxidant used in each of the layers of the photoconductor 1 in the present invention include the following compounds.

### [Monophenolic Compounds]

2,6-di-t-butyl-p-cresol, butylated hydroxyanisole, 2,6-di-t-butyl-4-ethylphenol, stearyl-β-(3,5-di-t-butyl-4-hydroxyphenyl)propionate, 3-t-butyl-4-hydroxyanisole and so forth

### [Bisphenolic Compounds]

2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-butylidenebis-(3-methyl-6-t-butylphenol) and so forth

### [Polymeric Phenolic Compounds]

1,1,3-tris-(2-methyl-4-hydroxy-5-t-butylphenyl)butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, bis[3,3′-bis(4′-hydroxy-3′-t-butylphenyl)butylic acid]glycol ester, tocophenols and so forth

[p-Phenylenediamines]

N-phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine, N,N′-dimethyl-N,N′-di-t-butyl-p-phenylenediamine and so forth

### [Hydroquinones]

2,5-di-t-octylhydroquinone, 2,6-didodecylhydroquinone, 2-dodecylhydroquinone, 2-dodecyl-5-chlorohydroquinone, 2-t-octyl-5-methylhydroquinone, 2-(2-octadecenyl)-5-methylhydroquinone and so forth

### [Organic Sulfur Compounds]

dilauryl-3,3′-thiodipropionate, distearyl-3,3′-thiodipropionate, ditetradecyl-3,3′-thiodipropionate and so forth

### [Organic Phosphorus Compounds]

triphenylphosphine, tri(nonylphenyl)phosphine, tri(dinonylphenyl)phosphine, tricresylphosphine, tri(2,4-dibutylphenoxy)phosphine and so forth

For the plasticizer used in each layer of the photoconductor 1 in the present invention, compounds generally used as a plasticizer for a resin can be used, including dibutyl phthalate and dioctyl phthalate. It is appropriate that the amount of the plasticizer used be about 0 parts by mass to about 30 parts by mass per 100 parts by mass of the binder resin.

A leveling agent may be added into the charge transporting layer of the photoconductor used in the present invention. Examples of the leveling agent include silicone oils such as dimethyl silicone oil and methylphenyl silicone oil; and polymers or oligomers having perfluoroalkyl groups in their side chains. It is appropriate that the amount of the leveling agent used be 0 parts by mass to 1 part by mass per 100 parts by mass of the binder resin.

As described above, the surface layer of the photoconductor 1 used in the present invention is provided in order to improve the mechanical strength, abrasion resistance, gas resistance, cleanability, etc. of the photoconductor 1. Examples of the material for the surface layer include a polymer, and a polymer with an inorganic filler dispersed therein, both of which have greater mechanical strength than the photoconductive layer. The polymer used for the surface layer may be a thermoplastic polymer or a thermosetting polymer, with a thermosetting polymer being preferred because it has high mechanical strength and is highly capable of reducing abrasion caused by friction with a cleaning blade. So long as the surface layer is thin, there may be no problem if it does not have charge transporting capability. However, when a surface layer not having charge transporting capability is formed so as to be thick, the photoconductor is easily caused to decrease in sensitivity, increase in electric potential after exposure, and increase in residual potential, so that it is desirable to mix the above-mentioned charge transporting material into the surface layer or use a polymer with charge transporting capability for the protective layer (surface layer).

Generally, the photosensitive layer and the surface layer greatly differ from each other in mechanical strength, so that once the protective layer (surface layer) is abraded due to friction with the cleaning blade and thusly disappears, the photosensitive layer is immediately abraded. Therefore, when the surface layer is provided, it is important to make it have a sufficient thickness. The thickness of the surface layer is 0.01 μm to 12 μm, preferably 1 μm to 10 μm, more preferably 2 μm to 8 μm. When the thickness of the surface layer is less than 0.01 μm, it is not desirable because the surface layer is so thin that parts of the surface layer easily disappear due to friction with the cleaning blade, and abrasion of the photosensitive layer progresses at a region corresponding to the missing parts in the surface layer. When the thickness of the surface layer is greater than 12 μm, it is not desirable because the photoconductor is easily caused to decrease in sensitivity, increase in electric potential after exposure, and increase in residual potential and, especially when a polymer with charge transporting capability is used, the cost of the polymer increases.

As the polymer used for the surface layer, a polymer which is transparent to writing light at the time of image formation and superior in insulation, mechanical strength and adhesiveness is desirable. Examples of such a polymer include resins such as ABS resins, ACS resins, olefin-vinyl monomer copolymers, chlorinated polyethers, allyl resins, phenol resins, polyacetals, polyamides, polyamide-imides, polyacrylates, polyallylsulfones, polybutylenes, polybutylene terephthalates, polycarbonates, polyethersulfones, polyethylenes, polyethylene terephthalates, polyimides, acrylic resins, polymethylpentenes, polypropylenes, polyphenylene oxides, polysulfones, polystyrenes, AS resins, butadiene-styrene copolymers, polyurethanes, polyvinyl chlorides, polyvinylidene chlorides and epoxy resins. The polymer exemplified by these may be a thermoplastic polymer; however, when a thermosetting polymer produced by crosslinkage with a multifunctional crosslinking agent having an acryloyl group, carboxyl group, hydroxyl group, amino group, etc. is used as the polymer to enhance its mechanical strength, the surface layer increases in mechanical strength and it becomes possible to greatly reduce abrasion caused by friction with the cleaning blade, which is preferred.

As described above, the surface layer of the photoconductor 1 preferably has charge transporting capability. In order for the surface layer to have charge transporting capability, it is possible to suitably employ, for example, a method in which a polymer used for the surface layer and the aforementioned charge transporting material are mixed together, or a method in which a polymer having charge transporting capability is used as the surface layer, with the latter method being preferable because a photoconductor which is highly sensitive and does not increase much in electric potential after exposure or in residual potential can be obtained.

Next will be described an intermediate transfer medium suitably used in the present invention. Although the intermediate transfer medium illustrated in FIG. 1 is an intermediate transfer belt 8, the shape of the intermediate transfer medium is not limited to a belt and may be cylindrical. The intermediate transfer medium used has a volume resistance (conductivity) of 10⁵ Ω·cm to 10¹¹ Ω·cm. When the volume resistance is lower than 10⁵ Ω·cm, the toner images may be changed during discharge upon transfer of the toner image from the photoconductor onto the intermediate transfer medium (so-called toner scattering during transfer). When the volume resistance exceeds 10¹¹ Ω·cm, the counter charges against the toner images remain on the intermediate transfer medium after transfer of the toner images from the intermediate transfer medium onto the recording medium such as paper, resulting in that an afterimage may be formed on the image obtained in the next cycle.

The intermediate transfer medium may be, for example, a belt-shaped or cylindrical plastic, which is formed by extruding a kneaded product of a thermoplastic resin and a conductive polymer and/or conductive particles such as carbon black and metal oxides (e.g., tin oxide and indium oxide). Alternatively, the intermediate transfer medium may be an endless belt which is formed through centrifugal molding under heating of a resin liquid containing a thermocrosslinkable monomer or oligomer and optionally containing the aforementioned conductive particles and/or conductive polymer. When a surface layer is provided on the intermediate transfer medium, the surface layer may be made of the composition containing the materials (except for the charge transport material) for forming a surface layer of the above-described photoconductor. In this case, the composition may be appropriately adjusted in resistance with a conductive compound before use.

Next, a toner able to be suitably used in the present invention will be described. First, a toner in the present invention preferably has an average circularity of 0.93 to 1.00. In the present invention, the value obtained from the following Equation (1) is defined as the circularity. The circularity indicates the degree of unevenness of a toner particle; when the toner particle is perfectly spherical, the circularity is 1.00; meanwhile, the more complex the surface shape of the toner particle becomes, the smaller the circularity becomes.

Circularity SR=Circumferential length of circle having the same area as projected particle area/Circumferential length of projected particle image Equation (1)

When the average circularity is in the range of 0.93 to 1.00, the surface of toner particles is smooth, and the area where the toner particles are in contact with one another and the area where the toner particles are in contact with the photoconductor are small, so that superior transferability can be obtained. Since the toner particles which form dots do not include angular toner particles, pressure is uniformly applied to the entire toner particles when they are transferred and pressed against a transfer medium, and thus absence of toner particles hardly arises during the transfer. The toner particles do not have angles, so that the torque with which a developer is agitated in a developing device can be reduced and the driving for agitation can be stabilized; therefore, abnormal images do not arise. Since the toner particles are not angular, the toner particles themselves have little abrasive power, thus not damaging or abrading the surface of the image bearing member.

Next, a method of measuring the circularity will be described.

The circularity can be measured using the flow-type particle image analyzer FPIA-1000 (product of SYSMEX CORPORATION). Specifically, 0.1 mL to 0.5 mL of a surfactant (preferably an alkylbenzene sulfonate) is added as a dispersing agent into 100 mL to 150 mL of water in a container, from which solid impurities have previously been removed. Then, about 0.1 g to about 0.5 g of a measurement sample (toner) is added to the container. The suspension in which the sample is dispersed is subjected to dispersing treatment by an ultrasonic dispersing device for about 1 min to about 3 min, and the concentration of the dispersed solution is adjusted such that the number of particles of the sample is 3,000 per microliter to 10,000 per microliter. At this state, the particle shape and particle size of the toner are measured using the above analyzer.

In the present invention, the weight average particle diameter D4 of the toner is preferably in the range of 3 μm to 10 μm. When the weight average particle diameter D4 is in this range, superior dot reproducibility can be obtained because the toner includes particles which are sufficiently small in diameter with respect to fine dots of a latent image. When the weight average particle diameter D4 is less than 3 μm, a phenomenon easily arises in which there is a decrease in transfer efficiency and blade cleaning capability. When the weight average particle diameter D4 is greater than 10 μm, it is difficult to reduce raggedness of lines and letters/characters.

The ratio (D4/D1) of the weight average particle diameter D4 of the toner to a number average particle diameter D1 of the toner is in the range of 1.00 to 1.40. The closer the value of the ratio (D4/D1) is to 1, the sharper the particle size distribution of the toner is. Thus, when the ratio (D4/D1) of the weight average particle diameter D4 to the number average particle diameter D1 is in the range of 1.00 to 1.40, differences in particle diameter of the toner do not cause particles to be unevenly used for image formation, so that the image quality can be excellently stabilized. Since the particle size distribution of the toner is sharp, the distribution of the frictional charge amount is also sharp, and thus the occurrence of fogging can be reduced. When the toner has a uniform particle diameter, a latent image is developed such that particles are accurately and neatly arranged on dots of the latent image, and thus superior dot reproducibility can be obtained.

Next, a method of measuring the particle size distribution of toner particles will be described. Examples of a measuring device for measuring the particle size distribution of toner particles in accordance with a Coulter counter method include COULTER COUNTER TA-II and COULTER MULTISIZER II (both of which are of Coulter Corporation). The following describes the method.

First, 0.1 mL to 5 mL of a surfactant (preferably an alkylbenzene sulfonate) is added as a dispersing agent into 100 mL to 150 mL of an aqueous electrolytic solution. Here, the electrolytic solution is an about 1% by mass NaCl aqueous solution prepared using primary sodium chloride. For the preparation, ISOTON-II (product of Coulter Corporation) can be used, for example. Then, 2 mg to 20 mg of a measurement sample (toner) is added. The aqueous electrolytic solution in which the sample is suspended is subjected to dispersing treatment by an ultrasonic dispersing device for about 1 min to about 3 min, then the volume of the toner or toner particles and the number of the toner particles are measured by the measuring device, using apertures of 100 μm, and the volume distribution and the number distribution are thus calculated. The weight average particle diameter D4 and the number average particle diameter D1 of the toner can be calculated from these distributions obtained. As channels, the following 13 channels are used, and particles having diameters which are equal to or greater than 2.00 μm but less than 40.30 μm are targeted: a channel of 2.00 μm or greater but less than 2.52 μm; a channel of 2.52 μm or greater but less than 3.17 μm; a channel of 3.17 μm or greater but less than 4.00 μm: a channel of 4.00 μm or greater but less than 5.04 μm: a channel of 5.04 μm or greater but less than 6.35 μm; a channel of 6.35 μm or greater but less than 8.00 μm; a channel of 8.00 μm tin or greater but less than 10.08 μM; a channel of 10.08 μm or greater but less than 12.70 μm; a channel of 12.70 μm or greater but less than 16.00 μm; a channel of 16.00 μm or greater but less than 20.20 μm; a channel of 20.20 μm or greater but less than 25.40 μm; a channel of 25.40 μm or greater but less than 32.00 μm; and a channel of 32.00 μm or greater but less than 40.30 μm.

For such a substantially spherical toner, it is preferable to use a toner obtained by crosslinking and/or elongating a toner composition including a polyester prepolymer which has a nitrogen atom-containing functional group, a polyester, a colorant and a releasing agent in the presence of fine resin particles in an aqueous medium. The toner produced by the crosslinking and/or elongating reaction makes it possible to reduce hot offset since the toner surface becomes hardened, and thus to restrain smears from being left on a fixing device and appearing on images.

Examples of prepolymers made of modified polyester resins, which can be used for producing toner, include isocyanate group-containing polyester prepolymers (A). Examples of compounds which elongate and/or crosslink with the prepolymers include amines (B). Examples of the isocyanate group-containing polyester prepolymers (A) include a compound obtained by reaction between a polyisocyanate (3) and a polyester which is a polycondensate of a polyol (1) and a polycarboxylic acid (2) and contains an active hydrogen group. Examples of the active hydrogen group of the polyester include hydroxyl groups (alcoholic hydroxyl groups and phenolic hydroxyl groups), amino groups, carboxyl group and mercapto group, with preference being given to alcoholic hydroxyl groups.

Examples of the polyol (1) include diols (1-1) and trihydric or higher polyols (1-2), and it is preferable to use any of the diols (1-1) alone, or mixtures each composed of any of the diols (1-1) and a small amount of any of the trihydric or higher polyols (1-2).

Examples of the diols (1-1) include alkylene glycols (e.g., ethylene glycol, 1,2-propylene glycol, 1,3-propylene glycol, 1,4-butanediol and 1,6-hexanediol); alkylene ether glycols (e.g., diethylene glycol, triethylene glycol, dipropylene glycol, polyethylene glycol, polypropylene glycol and polytetramethylene ether glycol); alicyclic diols (e.g., 1,4-cyclohexanedimethanol and hydrogenated bisphenol A); bisphenols (e.g., bisphenol A, bisphenol F and bisphenol S); adducts of the above alicyclic diols with alkylene oxides (e.g., ethylene oxide, propylene oxide and butylene oxide); and adducts of the above bisphenols with alkylene oxide (e.g., ethylene oxide, propylene oxide and butylene oxide). Among these, preference is given to alkylene glycols having 2 to 12 carbon atoms, and alkylene oxide adducts of bisphenols, and greater preference is given to alkylene oxide adducts of bisphenols, and combinations of the alkylene oxide adducts and alkylene glycols having 2 to 12 carbon atoms.

Examples of the trihydric or higher polyols (1-2) include trihydric to octahydric or higher aliphatic alcohols (e.g., glycerin, trimethylolethane, trimethylolpropane, pentaerythritol and sorbitol); trihydric or higher phenols (e.g., trisphenol PA, phenol novolac and cresol novolac); and alkylene oxide adducts of the above trihydric or higher phenols.

Examples of the polycarboxylic acid (2) include dicarboxylic acids (2-1) and trivalent or higher polycarboxylic acids (2-2), and it is preferable to use any of the dicarboxylic acids (2-1) alone, or mixtures each composed of any of the dicarboxylic acids (2-1) and a small amount of any of the trivalent or higher polycarboxylic acids (2-2).

Examples of the dicarboxylic acids (2-1) include alkylene dicarboxylic acids (e.g., succinic acid, adipic acid and sebacic acid); alkenylene dicarboxylic acids (e.g., maleic acid and fumaric acid); and aromatic dicarboxylic acids (e.g., phthalic acid, isophthalic acid, terephthalic acid and naphthalenedicarboxylic acid). Among these, preference is given to alkenylene dicarboxylic acids having 4 to 20 carbon atoms and aromatic dicarboxylic acids having 8 to 20 carbon atoms.

Examples of the trivalent or higher polycarboxylic acids (2-2) include aromatic polycarboxylic acids (e.g., trimellitic acid and pyromellitic acid) having 9 to 20 carbon atoms.

Additionally, the polycarboxylic acid (2) may be selected from acid anhydrides or lower alkyl esters (e.g., methyl ester, ethyl ester and isopropyl ester) of the aforementioned compounds and reacted with the polyol (1). As for the ratio of the polyol (1) to the polycarboxylic acid (2), the equivalence ratio [OH]/[COOH] of the hydroxyl group [OH] to the carboxyl group [COOH] is generally in the range of 2/1 to 1/1, preferably in the range of 1.5/1 to 1/1, more preferably in the range of 1.3/1 to 1.02/1.

Examples of the polyisocyanate (3) include aliphatic polyisocyanates (e.g., tetramethylene diisocyanate, hexamethylene diisocyanate and 2,6-diisocyanatomethyl caproate); alicyclic polyisocyanates (e.g., isophorone diisocyanate and cyclohexylmethane diisocyanate); aromatic diisocyanates (e.g., tolylene diisocyanate and diphenylmethane diisocyanate); aromatic aliphatic diisocyanates (e.g., α,α,α′,α′-tetramethylxylylene diisocyanate); isocyanurates; the polyisocyanates blocked with phenol derivatives, oximes, caprolactam, etc.; and combinations of two or more of them.

As for the amount of the polyisocyanate (3), the equivalence ratio [NCO]/[OH] of the isocyanate group [NCO] to the hydroxyl group [OH] of the hydroxyl group-containing polyester is generally in the range of 5/1 to 1/1, preferably in the range of 4/1 to 1.2/1, more preferably in the range of 2.5/1 to 1.5/1. When the equivalence ratio [NCO]/[OH] is greater than 5, there is a decrease in low-temperature fixing property. When the isocyanate group [NCO] is less than 1 in molar ratio, the amount of urea contained in the modified polyester is small, so that there is a decrease in hot offset resistance. The amount of components of the polyisocyanate (3) contained in the isocyanate-terminated prepolymer (A) is generally 0.5% by mass to 40% by mass, preferably 1% by mass to 30% by mass, more preferably 2% by mass to 20% by mass. When the amount thereof is less than 0.5% by mass, there is a decrease in hot offset resistance and there is a disadvantage in achieving a favorable balance between heat-resistant storageability and low-temperature fixing property. When the amount thereof is greater than 40% by mass, there is a decrease in low-temperature fixing property. The number of isocyanate groups contained per molecule in the isocyanate group-containing prepolymer (A) is generally 1 or more, preferably 1.5 to 3 on average, more preferably 1.8 to 2.5 on average. When the number thereof per molecule is less than 1 on average, the molecular weight of a urea-modified polyester is low, and thus there is a decrease in hot offset resistance.

Examples of the amines (B) include diamines (B1), trivalent or higher polyamines (B2), amino alcohols (B3), amino mercaptans (B4), amino acids (B5), and compounds (B6) obtained by blocking the amino groups of (B1) to (B5).

Examples of the diamines (B1) include aromatic diamines (e.g., phenylenediamine, diethyltoluenediamine and 4,4′-diaminodiphenylmethane); alicyclic diamines (e.g., 4,4′-diamino-3,3′-dimethyldicyclohexylmethane, diaminecyclohexane and isophoronediamine); and aliphatic diamines (e.g., ethylenediamine, tetramethylenediamine and hexamethylenediamine).

Examples of the trivalent or higher polyamines (B2) include diethylenetriamine and triethylenetetramine.

Examples of the amino alcohols (B3) include ethanolamine and hydroxyethylaniline.

Examples of the amino mercaptans (B4) include aminoethyl mercaptan and aminopropyl mercaptan.

Examples of the amino acids (B5) include aminopropionic acid and aminocaproic acid.

Examples of the compounds (B6) include oxazoline compounds and ketimine compounds derived from the amines of (B1) to (B5) and ketones (e.g., acetone, methy ethyl ketone and methyl isobutyl ketone).

Among these amines (B), preference is given to the diamines (B1), and mixtures containing any of the diamines (B1) and a small amount of any of the trivalent or higher polyamines (B2).

Further, an elongation terminator may, if necessary, be used so as to adjust the molecular weight of a urea-modified polyester. Examples of the elongation terminator include monoamines (e.g., diethylamine, dibutylamine, butylamine and laurylamine), and compounds (ketimine compounds) obtained by blocking the monoamines.

As for the amount of the amine (B), the equivalence ratio [NCO]/[NHx] of the isocyanate group [NCO] in the isocyanate group-containing prepolymer (A) to the amino group [NHx] in the amine (B) is generally in the range of 1/2 to 2/1, preferably in the range of 1.5/1 to 1/1.5, more preferably in the range of 1.2/1 to 1/1.2. When the equivalence ratio [NCO]/[NHx] is greater than 2 or less than 1/2, the molecular weight of a urea-modified polyester (i) is low, and thus there is a decrease in hot offset resistance. In the present invention, the urea-modified polyester (i) may contain a urethane bond as well as a urea bond. The molar ratio of the amount of the urea bond to the amount of the urethane bond is generally in the range of 100/0 to 10/90, preferably in the range of 80/20 to 20/80, more preferably in the range of 60/40 to 30/70. When the urea bond is less than 10% in molar ratio, there is a decrease in hot offset resistance.

Through the above-mentioned reactions, a modified polyester, particularly the urea-modified polyester (i), used for the toner in the present invention can be produced. The urea-modified polyester (i) is produced by a one-shot method or a prepolymer method. The weight average molecular weight of the urea-modified polyester (i) is generally 10,000 or greater, preferably 20,000 to 10,000,000, more preferably 30,000 to 1,000,000. When it is less than 10,000, there is a decrease in hot offset resistance. The number average molecular weight of the urea-modified polyester is not particularly limited when the after-mentioned unmodified polyester (ii) is additionally used; it may be such a number average molecular weight as helps obtain the above-mentioned weight average molecular weight. When the urea-modified polyester (i) is solely used, its number average molecular weight is generally 20,000 or less, preferably 1,000 to 10,000, more preferably 2,000 to 8,000. When it is greater than 20,000, there is a decrease in low-temperature fixing property and, if the urea-modified polyester (i) is used in a full-color apparatus, there is a decrease in glossiness.

Also in the present invention, instead of solely using the urea-modified polyester (i), an unmodified polyester (ii) may be additionally used as a binder resin component together with the urea-modified polyester (i). The use of the unmodified polyester (ii) together with the urea-modified polyester (i) is preferable to the use of the urea-modified polyester (i) alone because there is an increase in low-temperature fixing property and, if used in a full-color apparatus, there is an increase in glossiness. Examples of the unmodified polyester (ii) include a polycondensate of a polyol (1) and a polycarboxylic acid (2) similar to the components of the urea-modified polyester (i), and suitable examples thereof are also similar to those suitable for the urea-modified polyester (i). The unmodified polyester (ii) does not necessarily have to be an unmodified polyester and may be a polyester modified with a chemical bond other than urea bond, for example urethane bond. It is desirable in terms of low-temperature fixing property and hot offset resistance that the urea-modified polyester (i) and the unmodified polyester (ii) be compatible with each other at least partially. Accordingly, it is desirable that the urea-modified polyester (i) and the unmodified polyester (ii) have similar compositions. When the unmodified polyester (ii) is used, the ratio by mass of the urea-modified polyester (i) to the unmodified polyester (ii) is generally in the range of 5/95 to 80/20, preferably in the range of 5/95 to 30/70, more preferably in the range of 5/95 to 25/75, particularly preferably in the range of 7/93 to 20/80. When the ratio by mass of the urea-modified polyester (i) is less than 5%, there is a decrease in hot offset resistance and there is a disadvantage in achieving a favorable balance between heat-resistant storageability and low-temperature fixing property.

The peak molecular weight of the unmodified polyester (ii) is generally 1,000 to 30,000, preferably 1,500 to 10,000, more preferably 2,000 to 8,000. When it is less than 1,000, there is a decrease in heat-resistant storageability. When it is greater than 10,000, there is a decrease in low-temperature fixing property. The hydroxyl value of the unmodified polyester (ii) is preferably 5 or greater, more preferably 10 to 120, most preferably 20 to 80. When the hydroxyl value is less than 5, there is a disadvantage in achieving a favorable balance between heat-resistant storageability and low-temperature fixing property. The acid value of the unmodified polyester (ii) is generally 1 to 30, preferably to 20. With such an acid value, the formed toner tends to be easily negatively charged.

In the present invention, the glass transition temperature Tg of the binder resin is generally 50° C. to 70° C., preferably 55° C. to 65° C. When it is lower than 50° C., blocking worsens when the toner is stored at a high temperature. When it is higher than 70° C., the low-temperature fixing property is insufficient. By virtue of the presence of the urea-modified polyester together with the unmodified polyester, the dry toner in the present invention tends to be superior in heat-resistant storageability to known polyester toners even when the glass transition temperature is low. As for the storage elastic modulus of the binder resin, the temperature TG′ at which it is 10,000 dyne/cm², at a measurement frequency of 20 Hz, is generally 100° C. or higher, preferably 110° C. to 200° C. When the temperature is lower than 100° C., there is a decrease in hot offset resistance. As for the viscosity of the binder resin, the temperature Tη at which it is 1,000 P, at a measurement frequency of 20 Hz, is generally 180° C. or lower, preferably 90° C. to 160° C. When the temperature is higher than 180° C., there is a decrease in low-temperature fixing property. Accordingly, it is desirable in terms of a balance between low-temperature fixing property and hot offset resistance that TG′ be higher than Tη. In other words, the difference (TG′−Tη) between TG′ and Tη is preferably 0° C. or greater. It is more preferably 10° C. or greater, particularly preferably 20° C. or greater. The upper limit of the difference between TG′ and Tη is not particularly limited. Also, it is preferable in terms of a balance between heat-resistant storageability and low-temperature fixing property that the difference between Tη and Tg be 0° C. to 100° C. It is more preferably 10° C. to 90° C., particularly preferably 20° C. to 80° C.

The binder resin can be produced by the following method or the like. A polyol (1) and a polycarboxylic acid (2) are heated to a temperature of 150° C. to 280° C. in the presence of a known esterifying catalyst such as tetrabutoxy titanate or dibutyltin oxide, then water produced is distilled away, with a reduction in pressure if necessary, and a hydroxyl group-containing polyester is thus obtained. Subsequently, the obtained hydroxyl group-containing polyester is reacted with a polyisocyanate (3) at a temperature of 40° C. to 140° C. so as to obtain an isocyanate group-containing prepolymer (A). Further, the prepolymer (A) is reacted with an amine (B) at a temperature of 0° C. to 140° C. so as to obtain a urea-modified polyester. When the polyester is reacted with the polyisocyanate (3) and when the prepolymer (A) is reacted with the amine (B), a solvent may be used if necessary.

Examples of usable solvents include aromatic solvents (e.g., toluene and xylene), ketones (e.g., acetone, methyl ethyl ketone and methyl isobutyl ketone), esters (e.g., ethyl acetate), amides (e.g., dimethylformamide and dimethylacetamide) and ethers (e.g., tetrahydrofuran), which are inert to the polyisocyanate (3). In the case where a polyester (ii) which is not modified with a urea bond is additionally used, the polyester (ii) is produced in a manner similar to the production of the hydroxyl group-containing polyester, and the polyester (ii) is dissolved and mixed in a solution of the above-mentioned urea-modified polyester (i) in which reaction has finished.

In general, the toner used in the present invention can be produced by the following method. It should, however, be noted that other methods may be employed instead. Toner particles may be formed in the aqueous medium by reaction between the amine (B) and dispersoids made of the isocyanate group-containing prepolymer (A) or by using the urea-modified polyester (i) produced in advance. As a method for stably forming the dispersoids made of the prepolymer (A) and/or the urea-modified polyester (i) in the aqueous medium, there is, for example, a method of adding a toner material composition which includes the prepolymer (A) or the urea-modified polyester (i) into the aqueous medium and dispersing the composition by shearing force. The prepolymer (A) and other toner components (hereinafter referred to as “toner materials”) such as a colorant, a colorant master batch, a releasing agent, a charge controlling agent and an unmodified polyester resin may be mixed together when the dispersoids are formed in the aqueous medium; it is, however, more preferred to mix the toner materials together in advance, then add and disperse the mixture into the aqueous medium. Also in the present invention, the other toner materials such as a colorant, a releasing agent and a charge controlling agent do not necessarily have to be mixed when the particles are formed in the aqueous medium; the other toner materials may be added after the particles have been formed. For example, a colorant may be added in accordance with a known dyeing method after particles not containing a colorant have been formed.

The aqueous medium used in the present invention may be composed solely of water or composed of water and a solvent miscible with water. Examples of the solvent miscible with water include alcohols (e.g., methanol, isopropanol and ethylene glycol), dimethylformamide, tetrahydrofuran, cellusolves (e.g., methyl cellusolve) and lower ketones (e.g., acetone and methyl ethyl ketone).

The dispersing method is not particularly limited and may be appropriately selected depending on the intended purpose. The dispersing method may be selected from known methods such as low-speed shearing dispersion, high-speed shearing dispersion, frictional dispersion, high-pressure jet dispersion and ultrasonic dispersion. To make the dispersoids have a particle diameter of 2 μm to 20 μm, high-speed shearing dispersion is preferable. In the case where a high-speed shearing dispersing machine is used, the rotational speed is, although not particularly limited, generally 1,000 rpm to 30,000 rpm, preferably 5,000 rpm to 20,000 rpm. Although not particularly limited, the period of time for which the dispersion is performed is generally 0.1 min to 5 min when a batch method is employed. The temperature at the time of dispersion is generally 0° C. to 150° C. (under pressure), preferably 40° C. to 98° C. High temperatures are preferable in that the dispersion liquid made of the prepolymer (A) and/or the urea-modified polyester (i) are low in viscosity and thus the dispersion can be facilitated.

The amount of the aqueous medium used is generally 50 parts by mass to 2,000 parts by mass, preferably 100 parts by mass to 1,000 parts by mass, per 100 parts by mass of the toner composition which includes the prepolymer (A) and/or the urea-modified polyester (i). When the amount thereof is less than 50 parts by mass, the toner composition is in a poorly dispersed state, and thus toner particles having a predetermined diameter cannot be obtained. When the amount thereof is greater than 2,000 parts by mass, it is not desirable from an economical point of view. Additionally, a dispersing agent may be used if necessary. Use of a dispersing agent is preferable in that the particle size distribution becomes sharper and the dispersion can be stabilized.

As to a process of synthesizing the urea-modified polyester (i) from the prepolymer (A), the amine (B) may be added for reaction, before the toner composition is dispersed in the aqueous medium; alternatively, the amine (B) may be added after the toner composition has been dispersed in the aqueous medium, thus allowing reaction to occur from particle interfaces. In this case, the urea-modified polyester may be preferentially formed on the surface of the toner produced, and a concentration gradient may be thus provided inside toner particles.

Examples of the dispersing agent for emulsifying or dispersing in a water-containing liquid an oily phase in which a toner composition is dispersed include anionic surfactants such as alkylbenzene sulfonates, α-olefin sulfonates and phosphoric acid esters; cationic surfactants such as amine salts (e.g., alkylamine salts, aminoalcohol fatty acid derivatives, polyamine fatty acid derivatives and imidazoline) and quaternary ammonium salts (e.g., alkyltrimethyl ammonium salts, dialkyl dimethyl ammonium salts, alkyl dimethyl benzyl ammonium salts, pyridinium salts, alkyl isoquinolinium salts and benzetonium chloride); nonionic surfactants such as fatty acid amide derivatives and polyhydric alcohol derivatives; and amphoteric surfactants such as alanine, dodecyldi(aminoethyl)glycine,di(octylaminoethyl)glycine and N-alkyl-N,N-dimethylammoniumbetaine.

Use of a fluoroalkyl group-containing surfactant as the dispersing agent makes it possible to produce its effects even when used in very small amounts. Suitable examples of the fluoroalkyl group-containing surfactant include fluoroalkyl group-containing anionic surfactants and fluoroalkyl group-containing cationic surfactants.

Examples of the fluoroalkyl group-containing anionic surfactants include fluoroalkyl carboxylic acids having 2 to 10 carbon atoms, and metal salts thereof, disodium perfluorooctanesulfonylglutamate, sodium 3-[ω-fluoroalkyl (C6 to C11) oxy]-1-alkyl (C3 to C4) sulfonate, sodium 3-[ω-fluoroalkanoyl (C6 to C8)-N-ethylamino]-1-propanesulfonate, fluoroalkyl (C11 to C20) carboxylic acids and metal salts thereof, perfluoroalkylcarboxylic acids (C7 to C13) and metal salts thereof, perfluoroalkyl (C4 to C12) sulfonic acids and metal salts thereof, perfluorooctanesulfonic acid diethanolamide, N-propyl-N-(2-hydroxyethyl)perfluorooctanesulfonamide, perfluoroalkyl (C6 to C10) sulfonamide propyltrimethylammonium salts, perfluoroalkyl (C6 to C10)-N-ethylsulfonylglycine salts and monoperfluoroalkyl (C6 to C16) ethyl phosphoric acid esters.

Examples of commercially available products of the fluoroalkyl group-containing anionic surfactants include SURFLON S-111, S-112 and S-113 (these products are of Asahi Glass Co., Ltd.); FLUORAD FC-93, FC-95, FC-98 and FC-129 (these products are of Sumitomo 3M Limited); UNIDYNE DS-101 and DS-102 (these products are of DAIKIN INDUSTRIES, LTD.); MEGAFAC F-110, F-120, F-113, F-191, F-812 and F-833 (these products are of Dainippon Ink And Chemicals, Incorporated); EFTOP EF-102, 103, 104, 105, 112, 123A, 123B, 306A, 501, 201 and 204 (these products are of Tochem Products Co., Ltd.); and FTERGENT F-100 and F150 (these products are of NEOS COMPANY LIMITED).

Examples of the fluoroalkyl group-containing cationic surfactants include fluoroalkyl group-containing aliphatic primary, secondary or tertiary amine acids, aliphatic quaternary ammonium salts such as perfluoroalkyl (C6 to C10) sulfonamide propyltrimethylammonium salts, benzalkonium salts, benzetonium chloride, pyridinium salts and imidazolinium salts. Examples of commercially available products of the fluoroalkyl group-containing cationic surfactants include SURFLON S-121 (product of Asahi Glass Co., Ltd.), FLUORAD FC-135 (product of Sumitomo 3M Limited), UNIDYNE DS-202 (product of DAIKIN INDUSTRIES, LTD.), MEGAFAC F-150 and F-824 (there products are of Dainippon Ink And Chemicals, Incorporated), EFTOP EF-132 (product of Tochem Products Co., Ltd.), and FTERGENT F-300 (product of NEOS COMPANY LIMITED).

Also, as inorganic compound dispersing agents sparingly soluble in water, tricalcium phosphate, calcium carbonate, titanium oxide, colloidal silica, hydroxyappetite and the like may be used.

A polymeric protective colloid may be added to stabilize dispersion droplets. Examples of the polymeric protective colloid include homopolymers and copolymers formed from acids (e.g., acrylic acid, methacrylic acid, α-cyanoacrylic acid, α-cyanomethacrylic acid, itaconic acid, crotonic acid, fumaric acid, maleic acid and maleic anhydride); hydroxyl group-containing (meth)acrylic monomers (e.g., β-hydroxyethyl acrylate, β-hydroxyethyl methacrylate, β-βhydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, glycerinmonomethacrylic acid esters, N-methylolacrylamide and N-methylolmethacrylamide); vinyl alcohol and ethers of vinyl alcohol (e.g., vinyl methyl ether, vinyl ethyl ether and vinyl propyl ether); esters of carboxyl group-containing compounds and vinyl alcohol (e.g., vinyl acetate, vinyl propionate and vinyl butyrate); acrylamide, methacrylamide, diacetone acrylamide, and methylol compounds thereof, acid chlorides such as acrylic acid chloride and methacrylic acid chloride; nitrogen-containing compounds and nitrogen-containing heterocyclic ring-containing compounds such as vinyl pyridine, vinyl pyrolidone, vinyl imidazole and ethyleneimine; polyoxyethylene compounds such as polyoxyethylene, polyoxypropylene, polyoxyethylene alkylamine, polyoxypropylene alkylamine, polyoxyethylene alkylamide, polyoxypropylene alkylamide, polyoxyethylene nonyl phenyl ether, polyoxyethylene lauryl phenyl ether, polyoxyethylene stearyl phenyl ester and polyoxyethylene nonyl phenyl ester; and celluloses such as methyl cellulose, hydroxyethyl cellulose and hydroxypropyl cellulose.

In the case where a substance soluble in acid and/or alkali, such as a calcium phosphate salt, is used as a dispersion stabilizer, the substance is dissolved in an acid, e.g. hydrochloric acid, then the substance is removed from fine particles, for example by washing with water. Alternatively, its removal is enabled by a process such as enzymatic decomposition. In the case where the dispersing agent is used, the dispersing agent may remain on the toner particle surface; it is, however, preferable in terms of toner chargeability to remove the dispersing agent by washing after elongation and/or crosslinkage.

Further, to reduce the viscosity of the toner composition, a solvent may be used in which the urea-modified polyester (i) and the prepolymer (A) are soluble. Use of the solvent is preferable in that the particle size distribution becomes sharper. The solvent used is preferably volatile since it can easily be removed. Examples of the solvent include toluene, xylene, benzene, carbon tetrachloride, methylene chloride, 1,2-dichloroethane, 1,1,2-trichloroethane, trichloroethylene, chloroform, monochloro benzene, dichloroethylidene, methyl acetate, ethyl acetate, methyl ethyl ketone and methyl isobutyl ketone. These may be used alone or in combination. Of these, preferred are aromatic solvents such as toluene and xylene, and halogenated hydrocarbons such as methylene chloride, 1,2-dichloroethane, chloroform and carbon tetrachloride, and particularly preferred are aromatic solvents such as toluene and xylene. The amount of the solvent used is generally 0 parts by mass to 300 parts by mass, preferably 0 parts by mass to 100 parts by mass, more preferably 25 parts by mass to 70 parts by mass, per 100 parts by mass of the prepolymer (A). In the case where the solvent is used, it is removed by heating under normal or reduced pressure after elongation and/or crosslinkage.

The period of time for the elongation and/or the crosslinkage is selected depending on the reactivity between the isocyanate group structure of the prepolymer (A) and the amine (B) and is generally in the range of 10 min to 40 hr, preferably in the range of 2 hr to 24 hr. The reaction temperature is generally in the range of 0° C. to 150° C., preferably in the range of 40° C. to 98° C. If necessary, a known catalyst may be used. Specific examples thereof include dibutyltin laurate and dioctyltin laurate.

To remove the organic solvent from the emulsified dispersion liquid obtained, a method can be employed in which the entire system is gradually increased in temperature and the organic solvent in the liquid droplets is completely removed by evaporation. Alternatively, by spraying the emulsified dispersion liquid into a dry atmosphere and completely removing the water-insoluble organic solvent in the liquid droplets, fine toner particles can be formed, and also, the aqueous dispersing agent can be removed by evaporation. In general, examples of the dry atmosphere into which the emulsified dispersion liquid is sprayed include gases such as air, nitrogen, carbon dioxide and combustion gas which have been heated, especially flow of gasses heated to a temperature higher than or equal to the boiling point of the solvent used that has the highest boiling point. Treatments performed even in a short time using, for example, a spray dryer, a belt dryer or a rotary kiln allow the resultant product to have satisfactory quality. When the dispersoids having a broad particle size distribution are obtained during emulsifying or dispersing and are then subjected to washing and drying while the particle size distribution is being maintained, the dispersoids may be classified so as to have a desired particle size distribution.

As to the classification, fine particles can be removed by a cyclone separator, a decanter, a centrifuge, etc. in liquid. The classification may, of course, be carried out after particles have been obtained as powder through drying; nevertheless, it is desirable in terms of efficiency that the classification be carried out in liquid. Unnecessary fine or coarse particles produced may be returned to the kneading step again so as to be used for formation of particles. In this case, the fine or coarse particles may be in a wet state. It is preferable that the dispersing agent used be removed from the obtained dispersion liquid as much as possible and at the same time as the classification.

By mixing the obtained dried toner powder with foreign particles such as releasing agent fine particles, charge controlling fine particles, fluidizer fine particles and colorant fine particles and mechanically impacting the mixed powder, the different particles are fixed to and fused with the particle surface and thus it is possible to prevent exfoliation of the foreign particles from the surface of the composite particles obtained.

As specific means of obtaining the composite particles, there are, for example, a method of impacting the mixture, using a blade which rotates at high speed, and a method of pouring the mixture into a high-speed gas flow, accelerating the speed of the mixture and allowing particles to collide with one another or composite particles to collide with a appropriate collision plate. Examples of apparatuses for performing the foregoing include apparatuses in which the pulverization air pressure is reduced, made by modifying I-TYPE MILL (product of Nippon Pneumatic Mfg. Co., Ltd.) and ANGMILL (product of Hosokawa Micron Group); HYBRIDIZATION SYSTEM (product of NARA MACHINERY CO., LTD.); KRYPTRON SYSTEM (product of Kawasaki Heavy Industries, Ltd.); and automatic mortars.

Examples of the colorant used for the toner include pigments and dyes conventionally used as colorants for toners. Specific examples thereof include carbon black, lamp black, iron black, ultramarine, nigrosine dyes, aniline blue, phthalocyanine blue, phthalocyanine green, Hansa Yellow G, Rhodamine 6C Lake, chalco oil blue, chrome yellow, quinacridone red, benzidine yellow and rose bengal. These may be used alone or in combination.

Further, if necessary, magnetic components, for example iron oxides such as ferrite, magnetite and maghemite, metals such as iron, cobalt and nickel, and alloys composed of these and other metals, may be included alone or in combination in toner particles in order for the toner particles themselves to have magnetic properties. Also, these components may be used (also) as colorant components.

Also, the number average particle diameter of the colorant in the toner used in the present invention is preferably 0.5 μm or less, more preferably 0.4 μm or less, even more preferably 0.3 μm or less. When the number average particle diameter of the colorant in the toner is greater than 0.5 μm, the dispersibility of the pigment is insufficient, and thus favorable transparency cannot be obtained in some cases. When the colorant has a very small particle diameter of less than 0.1 μm, it is far smaller than the half wavelength of visible light; thus, it is thought that the colorant does not have an adverse effect on light-reflecting and -absorbing properties. Therefore, colorant particles which are less than 0.1 μm in diameter contribute to favorable color reproducibility and transparency of an OHP sheet with a fixed image. Meanwhile, when there are many colorant particles which are greater than 0.5 μm in particle diameter, transmission of incident light is disturbed and/or the incident light is scattered, and thus a projected image on an OHP sheet tends to decrease in brightness and vividness. Also, the presence of many colorant particles which are greater than 0.5 μm in particle diameter is not favorable because the colorant particles easily exfoliate from the toner particle surface, causing problems such as fogging, smearing of the drum and cleaning failure. It should be particularly noted that colorant particles which are greater than 0.7 μm in particle diameter preferably occupy 10% by number or less, more preferably 5% by number or less, of all colorant particles.

Also, by kneading the colorant together with part or all of a binder resin in advance with the addition of a wetting liquid, the colorant and the binder resin are sufficiently attached at an early stage, the colorant is effectively dispersed in toner particles in a subsequent toner production process, the dispersed particle diameter of the colorant becomes small, and thus more favorable transparency can be obtained. For the binder resin kneaded together with the colorant in advance, any of the resins shown above as examples of binder resins for the toner can be used directly; it should, however, be noted that the binder resin is not limited to the resins.

As a specific method of kneading a mixture of the colorant and the binder resin in advance with the addition of the wetting liquid, there is, for example, a method in which the binder resin, the colorant and the wetting liquid are mixed together using a blender such as HENSCHEL MIXER, then the obtained mixture is kneaded at a temperature lower than the melt temperature of the binder resin, using a kneader such as a two-roll kneader or three-roll kneader, and a sample is thus obtained. For the wetting liquid, a commonly-used one may be used, considering the solubility of the binder resin and the wettability thereof with the colorant; water and organic solvents such as acetone, toluene and butanone are favorable in terms of the dispersibility of the colorant. Among them, use of water is particularly preferred in view of care for the environment and maintenance of the colorant's dispersion stability in the subsequent toner production process. With this production method, colorant particles contained in the toner are small in particle diameter, and also, the particles are in a highly uniform dispersed state, so that the color reproducibility of an image projected by an OHP can be further improved.

Additionally, so long as the constitution of the present invention is employed, a releasing agent typified by wax may be contained in the toner along with the binder resin and the colorant. The releasing agent used may be a known releasing agent, and examples thereof include polyolefin waxes (e.g., polyethylene wax and polypropylene wax), long-chain hydrocarbons (e.g., paraffin wax and SASOLWAX) and carbonyl group-containing waxes.

Among these, carbonyl group-containing waxes are preferable. Examples thereof include polyalkanoic acid esters (e.g., carnauba wax, montan wax, trimethylolpropane tribehenate, pentaerythritol tetrabehenate, pentaerythritol diacetate dibehenate, glycerin tribehenate and 1,18-octadecanediol distearate), polyalkanol esters (e.g., tristearyl trimellitate and distearyl maleate), polyalkanoic acid amides (e.g., ethylenediamine dibehenyl amide), polyalkylamides trimellitic acid tristearyl amide) and dialkyl ketones (e.g., distearyl ketone). Among these carbonyl group-containing waxes, polyalkanoic acid esters are preferred.

The melting point of the releasing agent is generally 40° C. to 160° C., preferably 50° C. to 120° C., more preferably 60° C. to 90° C. Waxes which are lower than 40° C. in melting point have an adverse effect on heat-resistant storageability, and waxes which are higher than 160° C. in melting point are likely to cause cold offset during fixing at low temperatures. The melt viscosity of the wax is preferably 5 cps to 1,000 cps, more preferably 10 cps to 100 cps, when measured at a temperature higher than the melting point by 20° C. Waxes which are higher than 1,000 cps in melt viscosity are not much effective in improving low-temperature fixing property and hot offset resistance. The amount of wax contained in the toner is generally 0% by mass to 40% by mass, preferably 3% by mass to 30% by mass.

Additionally, to adjust the charged amount of the toner and allow toner particles to rise quickly in charged amount, a charge controlling agent may be contained in the toner if necessary. Here, if a colored material is used as the charge controlling agent, there is a change in color, so that use of a material which is colorless or whitish is preferable. The charge controlling agent may be selected from known charge controlling agents. Examples thereof include triphenylmethane dyes, molybdic acid chelate pigments, rhodamine dyes, alkoxy amines, quaternary ammonium salts (including fluorine-modified quaternary ammonium salts), alkylamides, phosphorus and phosphorus compounds, tungsten and tungsten compounds, fluorine-containing activating agents, metal salts of salicylic acid and metal salts of salicylic acid derivatives. Specific examples thereof include Bontron P-51 as a quaternary ammonium salt, E-82 as an oxynaphthoic acid metal complex, E-84 as a salicylic acid metal complex, and E-89 as a phenolic condensate (these products are of Orient Chemical Industries); TP-302 and TP-415 as quaternary ammonium salt molybdenum complexes (these products are of Hodogaya Chemical Industries); COPY CHARGE PSY VP2038 as a quaternary ammonium salt, COPY BLUE PR as a triphenylmethane derivative, and COPY CHARGE NEG VP2036 and COPY CHARGE NX VP434 as quaternary ammonium salts (these products are of Hoechst); LRA-901, and LR-147 as a boron complex (these products are of Japan Carlit Co., Ltd.); quinacridone, azo pigments; and polymeric compounds containing functional groups such as a sulfonic acid group, a carboxyl group and quaternary ammonium salt.

In the present invention, the amount of the charge controlling agent used is determined depending on the type of the binder resin, the presence or absence of optionally-used additive(s), and the toner production method including the dispersing method and so not unequivocally limited; however, the amount is in the range of 0.1 parts by mass to 10 parts by mass, preferably in the range of 0.2 parts by mass to 5 parts by mass, per 100 parts by mass of the binder resin. When the amount thereof is greater than 10 parts by mass, the chargeability of the toner is so great that effects of the charge controlling agent are reduced, and there is an increase in electrostatic attracting force toward a developing roller, causing a decrease in the fluidity of a developer and a decrease in image density. Such a charge controlling agent may be dissolved and dispersed in the toner after melted and kneaded together with a masterbatch and a resin, or may be directly added into an organic solvent when dissolved and dispersed therein, or may be fixed on the toner particle surface after the formation of toner particles.

When the toner composition is dispersed in the aqueous medium in the toner production process, fine resin particles mainly for stabilizing the dispersion may be added. For the fine resin particles, any resin (including thermoplastic resin and thermosetting resin) may be used as long as it is capable of forming an aqueous dispersion liquid. Examples thereof include vinyl resins, polyurethane resins, epoxy resins, polyester resins, polyamide resins, polyimide resins, silicon resins, phenol resins, melamine resins, urea resins, aniline resins, ionomer resins and polycarbonate resins. For the fine resin particles, any two or more of these resins may be used in combination. Among these resins, preferred are vinyl resins, polyurethane resins, epoxy resins, polyester resins, and combinations thereof, since an aqueous dispersion liquid of fine spherical resin particles can be easily obtained. As the vinyl resins, polymers each produced by homopolymerizing or copolymerizing a vinyl monomer are used. Examples thereof include, but are not limited to, styrene-(meth)acrylic acid ester resins, styrene-butadiene copolymers, (meth)acrylic acid-acrylic acid ester copolymers, styrene-acrylonitrile copolymers, styrene-maleic anhydride copolymers and styrene-(meth)acrylic acid copolymers.

Further, fine inorganic particles can be favorably used as an external additive to aid the developability and chargeability of toner particles. The fine inorganic particles preferably have a primary particle diameter of 5 μm to 2 mm, more preferably 5 μm to 500 μm. Also, the fine inorganic particles preferably have a BET specific surface area of 20 m²/g to 500 m²/g. The fine inorganic particles used preferably occupy 0.01% by mass to 5% by mass, more preferably 0.01% by mass to 2.0% by mass, of the toner. Specific examples of the fine inorganic particles include silica, alumina, titanium oxide, barium titanate, magnesium titanate, calcium titanate, strontium titanate, zinc oxide, tin oxide, silica sand, clay, mica, wollastonite, diatom earth, chromium oxide, cerium oxide, red ochre, antimony trioxide, magnesium oxide, zirconium oxide, barium sulfate, barium carbonate, calcium carbonate, silicon carbide and silicon nitride.

Further examples of the fine inorganic particles include fine polymeric particles exemplified by polymer particles of thermosetting resins, polycondensates such as Nylon, benzoguanamine and silicones, acrylic acid ester copolymers, methacrylic acid esters and polystyrene obtained by the soap-free emulsion polymerization, suspension polymerization or dispersion polymerization.

The fluidizing agent may be subjected to a surface treatment to increase the hydrophobicity thereof. Through this surface treatment, the flowability and charging property can be prevented from being degraded even under high-humidity conditions. Examples of preferred surface treatment agents include silane coupling agents, silylating agents, fluorinated alkyl group-containing silane coupling agents, organic titanate-containing coupling agents, aluminum-containing coupling agents, silicone oil and modified silicone oil.

Examples of a cleanability improver for removing a developer which remains on a photoconductor or an intermediate transfer medium after image transfer include metal salts of fatty acids such as stearic acid (e.g., zinc stearate and calcium stearate) and fine polymer particles produced by the soap-free emulsion polymerization or the like, such as fine polymethyl methacrylate particles and fine polystyrene particles. The fine polymer particles have a relatively narrow particle size distribution, and those which are 0.01 μm to 1 μm in volume average particle diameter are preferable.

Use of such a toner makes it possible to form a high-quality toner image superior in stability of development, as described above. However, toner particles which remain on the image bearing member, not having been transferred by a transfer device onto a transfer medium or an intermediate transfer medium, may possibly pass through the gap between the image bearing member and a cleaning device because the fineness and superior rotatability of the toner particles make it difficult for the cleaning device to remove them. To remove the toner particles completely from the image bearing member, it is necessary to press a toner removing member such as a cleaning blade against the image bearing member with strong force. Such a load not only shortens the service lives of the image bearing member and the cleaning device but also causes consumption of extra energy. In the case where the load on the image bearing member is reduced, removal of the toner particles and small-diameter carrier particles on the image bearing member is insufficient, and these particles do damage to the surface of the image bearing member when passing through the cleaning device, and thereby cause variation in the performance of the image forming apparatus.

As described above, since the image forming apparatus of the present invention is superior in terms of permissible ranges with respect to variation in the surface state of the photoconductor 1, especially with respect to the existence of low-resistance site(s), and has a structure in which variation in charging performance to the photoconductor 1, etc. is highly reduced, use of the image forming apparatus and the above-mentioned toner together makes it possible to stably obtain images of very high quality for a long period of time.

Also, it goes without saying that the image forming apparatus of the present invention can be used with a pulverized toner having an indefinite particle shape as well as with the above-mentioned toner suitable for obtaining high-quality images, and the service life of the apparatus can be greatly elongated. As the material for such a pulverized toner, any material usually used for electrophotographic toner can be used without any particular limitation.

Examples of commonly-used binder resins used for the pulverized toner include, but are not limited to, homopolymers of styrene and substituted products thereof, such as polystyrene, poly-p-chlorostyrene and polyvinyl toluene; styrene copolymers such as styrene-p-chlorostyrene copolymers, styrene-propylene copolymers, styrene-vinyl toluene copolymers, styrene-vinyl naphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chlormethacrylate copolymers, styrene-acrylonitrile copolymers, styrene-vinyl methyl ketone copolymers, styrene-butadiene copolymers, styrene-isoprene copolymers and styrene-maleic acid copolymers; homopolymers and copolymers of acrylic acid esters, such as polymethyl acrylate, polybutyl acrylate, polymethyl methacrylate and polybutyl methacrylate; polyvinyl derivatives such as polyvinyl chloride and polyvinyl acetate; polyester polymers, polyurethane polymers, polyamide polymers, polyimide polymers, polyol polymers, epoxy polymers, terpene polymers, aliphatic or alicyclic hydrocarbon resins and aromatic petroleum resins. These may be used alone or in combination and also employable binder resins are not limited thereto. It is particularly preferred in terms of electrical property, cost, etc. that the material be at least one selected from the group consisting of styrene-acrylic copolymer resins, polyester resins and polyol resins. Use of polyester resins and/or polyol resins is particularly preferred because of their favorable fixing properties.

In one employable production process for the pulverized toner, the resin component(s) is/are mixed with the above-mentioned colorant component(s), wax component(s) and charge controlling component(s) in advance if necessary, then they are kneaded at a temperature lower than or equal to a temperature in the vicinity of the melt temperature of the resin component(s), and the mixture is cooled and then subjected to pulverizing and classifying steps. If necessary, the above-mentioned externally added component(s) may be appropriately added and mixed therewith.

### Examples

The present invention will next be described in detail by way of Examples.

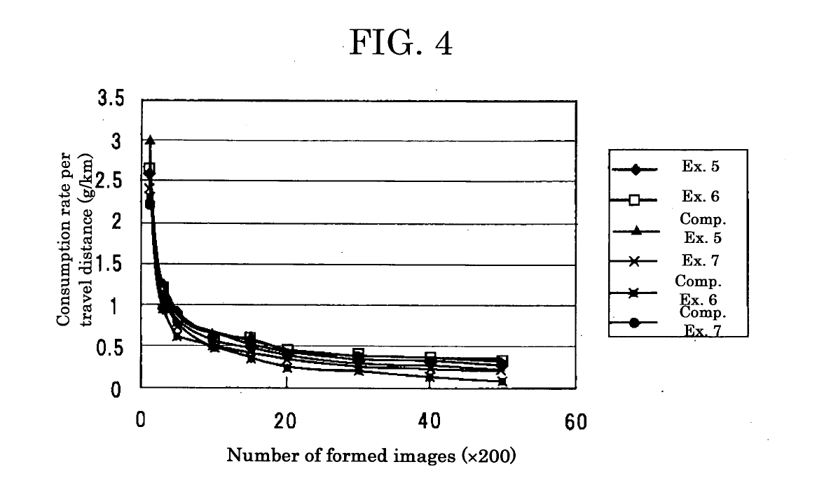

First, protecting agent blocks (Examples 1 to 7 and Comparative Examples 1 to 7) were each prepared so as to have the corresponding composition by the molding method as shown in Table 1. Each of the thus-prepared protecting agent blocks was mounted to a protective layer-forming unit in an image forming part of IMAGIO MP C4500 (product of Ricoh Company Ltd.) where the protective layer-forming unit was disposed downstream of the cleaning device but upstream of the charging device in the moving direction of the photoconductor. Then, 10,000 A4 paper sheets were continuously passed through the image forming apparatus for printing at an image occupation rate of 5%, and the following items were evaluated: change in consumption rate of the protecting agent block, cleanability (the degree of toner particles passing through the cleaning device), contamination of the charging roller, and protectability to the photoconductor. FIG. 3 shows changes in consumption rates of the melt-molded protecting agent blocks per travel distance. FIG. 4 shows changes in consumption rates of the compression-molded protecting agent blocks per travel distance. Notably, the “travel distance” means the cumulative distance over which the photoconductor is moved while being rotated. Table 2 shows evaluation results of the protecting agent blocks of Examples and Comparative Examples.

TABLE 1

| | Zinc | Calcium | Zinc | Boron | |
|---|---|---|---|---|---|
| | stearate | stearate | laurate | nitride | Molding method |
| Comp. Ex. 1 | 100% | | | | Melt molding |
| Comp. Ex. 2 | | 100% | | | Melt molding |
| Comp. Ex. 3 | 90% | | 10% | | Melt molding |
| Comp. Ex. 4 | 85% | | | 15% | Melt molding |
| Comp. Ex. 5 | 95% | | | 5% | Compression |
| | | | | | molding |
| Comp. Ex. 6 | 50% | | | 50% | Compression |
| | | | | | molding |
| Comp. Ex. 7 | 100% | | | | Compression |
| | | | | | molding |
| Ex. 1 | 98% | | | 2% | Melt molding |
| Ex. 2 | 95% | | | 5% | Melt molding |
| Ex. 3 | 92% | | | 8% | Melt molding |
| Ex. 4 | 88% | | | 12% | Melt molding |
| Ex. 5 | 80% | | | 20% | Compression |
| | | | | | molding |
| Ex. 6 | 85% | | | 15% | Compression |
| | | | | | molding |
| Ex. 7 | 60% | | | 40% | Compression |
| | | | | | molding |

Note that the unit “%” in Table 1 means “% by mass.”

TABLE 2

| | | Contamination against | Protectability to |
|---|---|---|---|
| | Cleanability | charging member | photoconductor |
| Comp. Ex. 1 | C | D | A |
| Comp. Ex. 2 | D | C | B |
| Comp. Ex. 3 | D | C | B |
| Comp. Ex. 4 | A | A | D |
| Comp. Ex. 5 | C | D | A |
| Comp. Ex. 6 | A | A | D |
| Comp. Ex. 7 | C | D | A |
| Ex. 1 | B | B | A |
| Ex. 2 | A | A | A |
| Ex. 3 | A | A | A |
| Ex. 4 | A | A | B |
| Ex. 5 | A | A | A |
| Ex. 6 | A | B | A |
| Ex. 7 | A | A | B |

<Cleanability>
A: Almost no toner particles passed through the cleaning device.
B: Although some toner particles passed through the cleaning device, no abnormal images were formed.
C: Many toner particles passed through the cleaning device to form abnormal images in some cases.
D: Abnormal images were formed frequently.
<Contamination against charging member>
A: The charging member was hardly contaminated.
B: Although the charging member was slightly contaminated, no adverse effects appeared on images at normal temperature.
C: Adverse effects appeared on images at low temperature.
D: Abnormal images were formed at an early stage.
<Protectability to photoconductor>
A: The photoconductor involved almost no abrasion and filming.
B: Filming was slightly observed; acceptable level.
C: Abnormal images were formed.
D: Severely abnormal image were formed.

As is clear from FIG. 3 and Table 2, the protecting agent blocks of Examples 1 to 4, each containing boron nitride in an amount of 2% by mass to 12% by mass together with the fatty acid metal salt (zinc stearate) and being formed by melt molding, involved small changes in consumption rate, and exhibited good cleanability, less contamination against the charging roller and good protectability to the photoconductor.

In contrast, the protecting agent blocks of Comparative Examples 1 and 2, containing the fatty acid metal salt only and being formed by melt molding, involved small changes in consumption rate but decreased in lubricity at an early stage due to the absence of boron nitride to cause passing through of the toner particles and contamination against the charging member. The protecting agent block of Comparative Example 3, containing two different fatty acid metal salts, increased in moldability but decreased in lubricity since the protecting agent block contained no boron nitride and was formed from different fatty acid metal salts. As a result, it caused passing through of the toner particles and contamination against the charging member. The protecting agent block of Comparative Example 4, containing boron nitride in an amount of 15% by mass and being formed by melt molding, was too hard due to boron nitride and thus was not desirably increased in consumption rate to exhibit poor protectability to the photoconductor.

Meanwhile, as is clear from FIG. 4 and Table 2, the protecting agent blocks 14 of Examples 5 to 7, containing boron nitride in an amount of 15% by mass to 40% by mass together with the fatty acid metal salt (zinc stearate) and being formed by compression molding, involved great changes in consumption rate but compensated failures due to those great changes since the amount of boron nitride contained was increased. As a result, they exhibited good cleanability, less contamination against the charging roller and good protectability to the photoconductor.

In contrast, the protecting agent block of Comparative Example 5, containing a small amount of boron nitride (i.e., 5% by mass), and the protecting agent block of Comparative Example 7, containing no boron nitride, considerably increased in consumption rate to frequently cause passing through of the fatty acid metal salt and thus accelerate contamination of the charging member. However, as seen in the protecting agent block of Comparative Example 6, when the amount of boron nitride contained is too large, the protecting agent block becomes too hard and thus cannot desirably increased in consumption rate to exhibit poor protectability to the photoconductor. In this case, for scraping off such a hard protecting agent block, it may be possible to increase the hardness of the brush fibers of the application brush, but hard brush fibers scrape off the photoconductor also, which is not practical.

As described above, the protecting agent block 14, which is an image bearing member-protecting agent according to the present embodiment, contains boron nitride in an amount of 13% by mass to 40% by mass together with a fatty acid metal salt and is formed by compression molding. The compression-molded protecting agent block 14 containing the fatty acid metal salt as a main component involves a great change in consumption rate, but contains other components such as boron nitride in such an amount as to compensate failures due to that great change in consumption rate. In this manner, even when the consumption rate of the protecting agent block 14 is high, the other components such as boron nitride can reduce the absolute amount of the fatty acid metal salt itself passing through, and hence can reduce the amount of the fatty acid metal salt scattered to the charging roller 2. In addition, even when the consumption rate is low, the other components such as boron nitride can aid the lubricity of the protecting agent block. Notably, the compression-molded protecting agent block 14 can be prevented from being too hardened even by the addition of the other components such as boron nitride. However, when the amount of the other components exceeds 40% by mass, the compression-molded protecting agent block becomes hard and decreases in consumption rate, which is not preferred.

The protecting agent block 14 according to the present embodiment, contains boron nitride in an amount of 1% by mass to 12% by mass together with a fatty acid metal salt and is formed by melt molding. The melt-molded protecting agent block 14 containing the fatty acid metal salt as a main component involves a small change in consumption rate. Thus, even when the amount of boron nitride contained is relatively small, the protective agent can be relatively stably supplied to the photoconductor 1. Notably, when the amount of the other components such as boron nitride exceeds 12% by mass, the melt-molded protecting agent block 14 becomes too hard and decreases in consumption rate, which is not preferred.

The protecting agent block 14 according to the present embodiment contains zinc stearate as the fatty acid metal salt. Zinc stearate exhibits more excellent cleanability and photoconductor protectability than the other fatty acid metal salts. Also, stearic acid is the cheapest among higher fatty acids, and a zinc salt of stearic acid is a highly hydrophobic, remarkably stable compound.

The protective layer-forming unit 7 according to the present embodiment uses the above-described protecting agent block 14, and thus can prevent for a long period of time passing through of toner particles, contamination against a charging unit as well as abrasion and filming of an image bearing member.

In the protective layer-forming unit 7 according to the present embodiment, the protecting agent is supplied to a surface of the photoconductor 1 via the application brush 15 serving as a protecting agent-supplying member. In general, protecting agents relatively easily undergo plastic deformation since they exhibit protection effects when applied onto the surface of the photoconductor 1 to form a film. Therefore, when the protecting agent block 14 in the form of block is directly pressed against the surface of the photoconductor 1 to form a protective layer, the amount of the protecting agent is excessively large, so that the efficiency of protective layer formation is not desired. In addition, in some cases, the formed protective layer has a laminated layer structure to prevent light transmission at an exposure step of, for example, forming a latent electrostatic image. As a result, limitation is imposed on the type of employable protecting agents. In contrast, the protective layer-forming unit 7 according to the present embodiment uses the application brush 15 between the protecting agent block 14 and the photoconductor 1 and thus, can uniformly supply an even soft protecting agent block 14 to the surface of the photoconductor 1.

The protective layer-forming unit 7 according to the present embodiment has a leveling blade 16 serving as a coating film-forming member which can form a uniform protective layer on the photoconductor 1.

A printer that is an image forming apparatus according to the present embodiment uses the protective layer-forming unit 7 containing the protecting agent block 14. With this configuration, it is possible to prevent for a long period of time passing through of toner particles, contamination against a charging member as well as abrasion and filming of an image bearing member. In addition, it is also possible to obtain high-durability, high-quality images.

The printer according to the present embodiment has a cleaning unit 6 (cleaning blade 11) configured to remove residual matter on the photoconductor 1 where the cleaning unit 6 is located downstream of a transfer roller 5 but upstream of the protective layer-forming unit 7 in the moving direction of the photoconductor. When the protective layer-forming unit 7 is provided with the leveling blade 16 for forming the protecting agent into a coating film, this leveling blade 16 may serve also as the cleaning member. To more reliably form a protective layer, preferably, residual matter mainly containing toner is removed in advance with the cleaning blade 11 from the photoconductor 1 so as to avoid inclusion of the residual matter in the protective layer.

The photoconductor 1 in the printer according to the present embodiment has an uppermost layer containing a thermosetting resin. By preventing the photoconductor 1 from degradation due to electrical stress using the protecting agent, the photoconductor 1 containing the thermosetting resin can continue to exhibit durability to mechanical stress for a long period of time. As a result, the photoconductor 1 can be increased in durability to such a level that substantially no replacement is required.

In the printer according to the present embodiment, the photoconductor 1 is uniformly charged by a charging roller 2 disposed so as to be in contact with or proximately to the surface of the photoconductor 1. In this configuration, the charging region is very near the photoconductor 1, so that electrical stress applied to the photoconductor 1 tends to increase. However, the above-described protective layer can protect the photoconductor 1 from such electrical stress that is applied to the photoconductor during use.

The printer according to the present embodiment has a charging roller 2 having a power source, serving as a voltage-applying unit configured to apply a voltage containing an alternating-current component. By virtue of superposition of the alternating-current component, contamination of the charging roller 2 causes a less degree of abnormal charging as compared with the case where only a direct-current component is applied using a contact-type charging roller. Also, the superposition of the alternating-current component tends to increase electrical stress applied to the surface of the photoconductor 1. However, the above-described protective layer can protect the photoconductor 1 from such electrical stress that is applied to the photoconductor during use.

In the printer according to the present embodiment, even when the image bearing member is an intermediate transfer belt 8, the above-described protective layer-forming unit can be disposed above the intermediate transfer belt 8 to increase durability and cleanability of the intermediate transfer belt 8.

The printer according to the present embodiment uses spherical toner particles having circularity of 0.93 to 1.00. Even when using high-circularity spherical toner particles whose cleanability is sensitively varied depending on changes in surface conditions of the photoconductor 1, use of the above-described protective layer can stably maintain their cleanability high for a long period of time.

The printer according to the present embodiment uses toner particles having uniform particle diameters; i.e., having a ratio (D4/D1) of 1.00 to L40 where D4 denotes a weight average particle diameter and D1 denotes a number average particle diameter. Even when using uniform toner particles whose cleanability is sensitively varied depending on changes in surface conditions of the photoconductor 1, use of the above-described protective layer can stably maintain their cleanability high for a long period of time.

In the printer according to the present embodiment, at least the photoconductor 1 and the protective layer-forming unit 7 are integrally included in a process cartridge which is detachably mounted to a main body of the apparatus. As described above, the lubricity on the surface of the photoconductor 1 can be maintained high for a long period of time, so that durability to electrical stress is improved. As a result, the replacement interval of the process cartridge can be set remarkably long to reduce running cost and considerably reduce wastes. Especially when a layer containing a thermosetting resin is formed on the surface of the photoconductor 1, durability to mechanical stress can be obtained continuously for a long period of time. As described above, the protecting agent is substantially free of metal components and thus, does not cause contamination due to the metal oxide or the like against the charging roller 2 disposed proximately or in a contact manner, to thereby reduce changes over time of the charging roller 2. Furthermore, the constituent components of the process cartridge such as the photoconductor 1 and the charging roller 2 can easily be recycled to attain further waste reduction.

This application claims priority to Japanese patent application No. 2010-206696, filed on Sep. 15, 2010, and incorporated herein by reference.

What is claimed is:

1. An image bearing member-protecting agent comprising:
a fatty acid metal salt, and
boron nitride,
wherein the image bearing member-protecting agent contains the fatty acid metal salt in an amount of 60% by mass to 87% by mass, and is formed by compression molding.

2. An image bearing member-protecting agent comprising:
a fatty acid metal salt, and
boron nitride,
wherein the image bearing member-protecting agent contains the fatty acid metal salt in an amount of 88% by mass to 99% by mass, and is formed by melt molding.

3. The image bearing member-protecting agent according to claim 1, wherein the fatty acid metal salt is zinc stearate.

4. A protective layer-forming device comprising:
an image bearing member-protecting agent,
wherein the protective layer-forming device is configured to apply or attach the image bearing member-protecting agent onto a surface of an image bearing member, and
wherein the image bearing member-protecting agent is the image bearing member-protecting agent according to claim 1.

5. The protective layer-forming device according to claim 4, further comprising a protecting agent-supplying member,
wherein the protecting agent-supplying member scrapes off the image bearing member-protecting agent and comes into contact with the image bearing member to supply the image bearing member-protecting agent to the image bearing member.

6. The protective layer-forming device according to claim 4, further comprising a coating film-forming member,
wherein the coating film-forming member presses the image bearing member-protecting agent supplied onto the image bearing member to form a coating film on the image bearing member.
